(19) United States
(12) Patent Application Publication
(10) Pub. No.: US 2015/0212691 A1
(43) Pub. Date: Jul. 30, 2015

(54) METHOD AND APPARATUS FOR DESKTOP MANAGEMENT

(71) Applicant: Tencent Technology (Shenzhen) Company Limited, Shenzhen, GU (CN)

(72) Inventors: Donglei Wang, Shenzhen (CN); Haodan Pan, Shenzhen (CN); Fang Li, Shenzhen (CN); Houcong Zhu, Shenzhen (CN); Neng Liu, Shenzhen (CN); Shixiang Wu, Shenzhen (CN); Jun Ma, Shenzhen (CN); Song Fang, Shenzhen (CN); Zhonghui Zhang, Shenzhen (CN)

(73) Assignee: Tencent Technology (Shenzhen) Company Limited, Shenzhen (CN)

(21) Appl. No.: 14/424,885

(22) PCT Filed: Aug. 30, 2013
(86) PCT No.: PCT/CN2013/082675

§ 371 Date: Feb. 27, 2015

(30) Foreign Application Priority Data
Aug. 31, 2012 (CN) 201210318769.9

(51) Int. Cl. G06F 3/0481; G06F 3/0482; G06F 3/0484

(52) U.S. Cl. CPC G06F 3/04817; G06F 3/04842; G06F 3/0482

(57) ABSTRACT

Disclosed are a desktop management method and device, which belong to the technical field of terminals. The method comprises: monitoring a gesture operation event of a current screen; when a first designated event is monitored, displaying a desktop management menu, the desktop management menu comprising all the screen thumbnails of the desktop; and when a second designated event is monitored, according to the second designated event, processing an operation object of the first designated event and a screen corresponding to a target thumbnail of the second designated event in the desktop management menu. The present invention can achieve the purpose of quickly locating a screen, thereby making an operation performed on a desktop be simple and quick, and the efficiency of the operation be high.

### CROSS-REFERENCE TO RELATED APPLICATIONS

This application claims the priority benefit of Chinese Patent Application No. 201210318769.9 filed on Aug. 31, 2012 and entitled “method and apparatus for desktop management”, the contents of which are incorporated by reference herein in their entirety for all purposes.

### TECHNICAL FIELD

The disclosure relates to terminals, in particular, to a method and an apparatus for desktop management.

### BACKGROUND

As development of terminal technology, smart terminals are broadly used. For efficient and convenient usage and management of the smart terminals, technologies for the desktop management of the smart terminals become mature. Skins, themes, and desktop tools with rich functions are provided to users in various forms such as icon display or application display.

In prior arts, the desktop management may be implemented by users' various gestures to the desktop screen when the desktop is displayed in full screen.

Inventors of the present invention find that the prior arts have at least the following problems:

In existing methods for desktop management, in order to move a target in the desktop, it is needed to slide on the screen to a target screen in which the target is to be located according to the sequence of screens. In such methods, one slide action only switches one screen and takes a long holding time, resulting in low efficiency and poor user experience.

### SUMMARY

To overcome the problems in the prior art, a method and an apparatus for desktop management are provided in embodiments of the disclosure. The technical solutions are as follows.

A method for managing a desktop comprises:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored.

Optionally, displaying a desktop management menu which comprises thumbnails of all screens of the desktop when a first designated event is monitored comprises:
when the first designated event is monitored, retrieving data of all screens of the desktop from a desktop management database, generating a thumbnail of each of the screens correspondingly according to the data of all screens of the desktop, and displaying the desktop management menu which comprises thumbnails of all screens of the desktop.

Optionally, processing an operation object of the first designated event and a screen corresponding to a target thumbnail of a second designated event in the desktop management menu according to the second designated event when the second designated event is monitored comprises:
recording icon information of at least one icon in the current screen when the second designated event is monitored and the operation object of the first designated event is the at least one icon;
rendering the at least one icon as a user's finger moves according to moving coordinates of the user's finger and the icon information of the at least one icon; and
adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

Optionally, the method further comprises:
calculating remaining space of the screen corresponding to the first thumbnail when the moving coordinates of the user's finger enter the range of the first thumbnail while the at least one icon is rendered as the user's finger moves;
determining whether the screen corresponding to the first thumbnail has enough remaining space to accommodate the at least one icon according to the remaining space and a number of the at least one icon; and
displaying a first color in the range of the first thumbnail if it is the case, and displaying a second color in the range of the first thumbnail if it is not the case.

Optionally, the method further comprises:
calculating remaining space of the screen corresponding to each thumbnail in the desktop management menu when the second designated event is monitored;
determining whether the screen corresponding to each thumbnail has enough remaining space to accommodate the at least one icon according to the remaining space of the each thumbnail and a number of the at least one icon;
displaying a first color in the range of thumbnails corresponding to the screens having enough remaining space to accommodate the at least one icon if it is the case; and
displaying a second color in the range of thumbnails corresponding to the screens having insufficient remaining space to accommodate the at least one icon if it is not the case.

Optionally, adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail comprises:
determining whether a first thumbnail, which is any one thumbnail in the desktop management menu, has enough remaining space to accommodate the at least one icon when it is monitored that the second designated event is ended and the moving coordinates of the user's finger in the second designated event enter the range of the first thumbnail, and adding the at least one icon into the screen corresponding to the first thumbnail according to the recorded icon information of the at least one icon if it is the case.

Optionally, the method further comprises:
recovering the at least one icon in an original screen of the at least one icon when the first thumbnail does not have enough remaining space to accommodate the at least one icon.

Optionally, the first designated event is a long-press event to the at least one icon, and the second designated event is a drag event to the at least one icon.

Optionally, displaying a desktop management menu which comprises thumbnails of all screens of the desktop when a first designated event is monitored comprises:
switching the current screen into a drag and drop mode when the first designated event is monitored.

Optionally, processing an operation object of the first designated event and a screen corresponding to a target thumbnail of a second designated event in the desktop management menu according to the second designated event when the second designated event is monitored comprises:
acquiring clicking coordinates of the user's finger in the second designated event when the second designated event is monitored and the operation object of the first designated event is the current screen;
the thumbnail in the desktop management menu in which the clicking coordinates are located being the target thumbnail of the second designated event; and
switching the current screen to the screen in the desktop management menu corresponding to the target thumbnail.

Optionally, switching the current screen to the screen in the desktop management menu corresponding to the target thumbnail comprises:
acquiring an index number of the screen corresponding to the target thumbnail; and
switching the current screen to the screen in the desktop management menu corresponding to the target thumbnail according to the index number of the screen corresponding to the target thumbnail.

Optionally, the first designated event is a slide event in which the user's finger slides upwardly by a distance long than or equal to a designated distance, and the second designated event is a clicking event.

Optionally, processing an operation object of the first designated event and a screen corresponding to a target thumbnail of a second designated event in the desktop management menu according to the second designated event when the second designated event is monitored comprises:
recording information of a second thumbnail in the desktop management menu when the second designated event is monitored, the operation object of the first designated event is the current screen, and the operation object of the second designated event is the second thumbnail;
rendering the second thumbnail as the user's finger moves according to the moving coordinates of the user's finger in the second designated event and the information of the second thumbnail; and
modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

Optionally, modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail comprises:
when it is monitored that the second designated event is ended, calculating an overlapped area between the second thumbnail and the third thumbnail according to the moving coordinates of the user's finger when the second designated event is ended, wherein, if the overlapped area is larger than a preset value, it is determined that the the moving coordinates of the user's finger in the second designated event enter the range of the third thumbnail;
switching the location of the second thumbnail to the location of the third thumbnail in the desktop management menu, and switching the location of the third thumbnail to the original location of the second thumbnail or moving the locations of the third thumbnail and thumbnails following the third thumbnail sequentially in the rearward direction according to the information of the second thumbnail and the information of the third thumbnail.

Optionally, the method further comprises:
switching the desktop management menu into a drag and drop mode when the second designated event is monitored, the operation object of the first designated event is the current screen and the operation object of the second designated event is the second thumbnail in the desktop management menu.

Optionally, the first designated event is a slide event in which the user's finger slides upwardly by a distance longer than or equal to a designated distance, and the second designated event is a long-press and drag event to the second thumbnail.

Optionally, after processing an operation object of the first designated event and a screen corresponding to a target thumbnail of a second designated event in the desktop management menu according to the second designated event when the second designated event is monitored, the method further comprising:
updating data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

Optionally, after processing an operation object of the first designated event and a screen corresponding to a target thumbnail of a second designated event in the desktop management menu according to the second designated event when the second designated event is monitored, the method further comprising:
contracting the desktop management menu; or
contracting the desktop management menu when a third designated event is received.

An apparatus for managing a desktop comprises:
a monitoring module, configured to monitor a gesture operation event to a current screen;
a displaying module, configured to display a desktop management menu which comprises thumbnails of all screens of the desktop when a first designated event is monitored; and
a processing module, configured to process an operation object of the first designated event and a screen corresponding to a target thumbnail of a second designated event in the desktop management menu according to the second designated event when the second designated event is monitored.

The displaying module is configured to, when the first designated event is monitored, retrieve data of all screens of the desktop from a desktop management database, generate a thumbnail of each of the screens correspondingly according to the data of all screens of the desktop, and display the desktop management menu which comprises thumbnails of all screens of the desktop.

The processing module comprises:
a recording unit, configured to record icon information of at least one icon in the current screen when the second designated event is monitored and the operation object of the first designated event is the at least one icon;
a rendering unit, configured to render the at least one icon as a user's finger moves according to moving coordinates of the user's finger and the icon information of the at least one icon; and
a processing unit, configured to add the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

The apparatus further comprises:
a first calculating unit, configured to calculate remaining space of the screen corresponding to the first thumbnail when the moving coordinates of the user's finger enter the range of the first thumbnail while the at least one icon is rendered as the user's finger moves;
a first determining module, configured to determine whether the screen corresponding to the first thumbnail has enough remaining space to accommodate the at least one icon according to the remaining space and a number of the at least one icon, wherein the displaying module is triggered to display a first color in the range of the first thumbnail if the first determining module determines that the screen corresponding to the first thumbnail has enough remaining space to accommodate the at least one icon, and the displaying module is triggered to display a second color in the range of the first thumbnail if the first determining module determines that the screen corresponding to the first thumbnail does not have enough remaining space to accommodate the at least one icon.

The apparatus further comprises:
a second calculating module, configured to calculate remaining space of the screen corresponding to each thumbnail in the desktop management menu when the second designated event is monitored;
a second determining module, configured to determine whether the screen corresponding to each thumbnail has enough remaining space to accommodate the at least one icon according to the remaining space of the each thumbnail and a number of the at least one icon, wherein the displaying module is triggered to display a first color in the range of thumbnails corresponding to the screens having enough remaining space to accommodate the at least one icon if it is the case; and the displaying module is triggered to display a second color in the range of thumbnails corresponding to the screens having insufficient remaining space to accommodate the at least one icon if it is not the case.

The processing unit is configured to determine, when it is monitored that the second designated event is ended and the moving coordinates of the user's finger in the second designated event enter a range of the first thumbnail, whether a first thumbnail, which is any one thumbnail in the desktop management menu, has enough remaining space to accommodate the at least one icon, and add the at least one icon into the screen corresponding to the first thumbnail according to the recorded icon information of the at least one icon if it is the case.

The apparatus further comprises:
a recovering module, configured to recover the at least one icon in an original screen of the at least one icon when the first thumbnail does not have enough remaining space to accommodate the at least one icon.

The first designated event is a long-press event to the at least one icon, and the second designated event is a drag event to the at least one icon.

The apparatus according to any of claims 19-26, further comprising:
a first mode switching module, configured to switch the current screen into a drag and drop mode when the first designated event is monitored.

The processing module comprises:
an acquiring unit, configured to acquire clicking coordinates of the user's finger in the second designated event when the second designated event is monitored and the operation object of the first designated event is the current screen, wherein the thumbnail in the desktop management menu in which the clicking coordinates are located is the target thumbnail of the second designated event; and
a switching unit, configured to switch the current screen to the screen in the desktop management menu corresponding to the target thumbnail.

The switching unit is configured to acquire an index number of the screen corresponding to the target thumbnail, and switch the current screen to the screen in the desktop management menu corresponding to the target thumbnail according to the index number of the screen corresponding to the target thumbnail.

The first designated event is a slide event in which the user's finger slides upwardly by a distance long than or equal to a designated distance, and the second designated event is a clicking event.

The processing module comprises:
a thumbnail information recording unit, configured to record information of a second thumbnail in the desktop management menu when the second designated event is monitored, the operation object of the first designated event is the current screen, and the operation object of the second designated event is the second thumbnail;
a thumbnail rendering unit, configured to render the second thumbnail as the user's finger moves according to the moving coordinates of the user's finger in the second designated event and the information of the second thumbnail; and
a modifying unit, configured to modify a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

The modifying unit is configured to calculate, when it is monitored that the second designated event is ended, an overlapped area between the second thumbnail and the third thumbnail according to the moving coordinates of the user's finger when the second designated event is ended, wherein, if the overlapped area is larger than a preset value, it is determined that the the moving coordinates of the user's finger in the second designated event enter the range of the third thumbnail; and is configured to switch the location of the second thumbnail to the location of the third thumbnail in the desktop management menu, and switch the location of the third thumbnail to the original location of the second thumbnail or move the locations of the third thumbnail and thumbnails following the third thumbnail sequentially in the rearward direction according to the information of the second thumbnail and the information of the third thumbnail.

The apparatus further comprises:
a second mode switching module, configured to switch the desktop management menu into a drag and drop mode when the second designated event is monitored, the operation object of the first designated event is the current screen and the operation object of the second designated event is the second thumbnail in the desktop management menu.

The first designated event is a slide event in which the user's finger slides upwardly by a distance longer than or equal to a designated distance, and the second designated event is a long-press and drag event to the second thumbnail.

The apparatus further comprises:
an updating module, configured to update data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

The apparatus further comprises:
a desktop management menu processing module, configured to contract the desktop management menu; or contract the desktop management menu when a third designated event is received.

In another aspect, provided is a terminal which comprises:
a memory; and
one or more programs stored in the memory and configured to be executed by one or more processors, the one or more programs including instructions for performing the following operations:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored.

In another aspect, provided is a readable storing medium stored with one or more programs configured to be executed by one or more processors to perform a desktop management method comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored.

According to the method and apparatus for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient.

### DESCRIPTION OF THE DRAWINGS

In order to illustrate technical solutions in embodiments of the disclosure more clearly, drawings used in the description of the embodiments are described briefly as below. It is obvious that the drawings are provided to describe some embodiments of the disclosure. For an ordinary person in the art, other drawings for other embodiments can be obtained without any inventive work.

FIG. 1 is a flowchart of a method for desktop management according to an embodiment of the disclosure.

FIG. 2a is a flowchart of a method for desktop management according to an embodiment of the disclosure.

FIG. 2b is a schematic diagram of a method for desktop management according to an embodiment of the disclosure.

FIG. 3a is a flowchart of a method for desktop management according to an embodiment of the disclosure.

FIG. 3b is a schematic diagram of a method for desktop management according to an embodiment of the disclosure.

FIG. 4a is a flowchart of a method for desktop management according to an embodiment of the disclosure.

FIG. 4b is a schematic diagram of a method for desktop management according to an embodiment of the disclosure.

FIG. 5a is a flowchart of a method for desktop management according to an embodiment of the disclosure.

FIG. 5b is a schematic diagram of a method for desktop management according to an embodiment of the disclosure.

FIG. 6a is a flowchart of a method for desktop management according to an embodiment of the disclosure.

FIG. 6b is a schematic diagram of a method for desktop management according to an embodiment of the disclosure.

FIG. 7 is a schematic structural block view of an apparatus for desktop management according to an embodiment of the disclosure.

FIG. 8 is a schematic structural block view of a terminal to an embodiment of the disclosure.

FIG. 9 is a schematic structural block view of a computer-readable storage medium according to an embodiment of the disclosure.

### DETAILED DESCRIPTION

In order to make the objects, technical solutions and advantages of the disclosure more apparent, embodiments will be further illustrated in details in connection with the accompanying figures hereinafter.

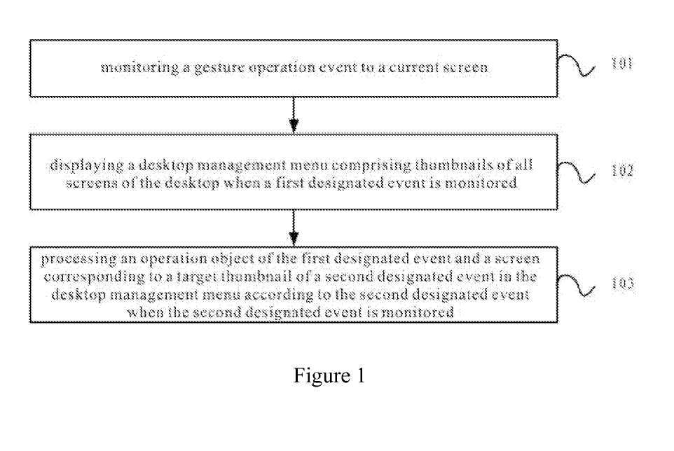

FIG. 1 is a flowchart of a method for desktop management according to an embodiment of the disclosure. The subject to perform the embodiment is a terminal device with touch-screen functions. As shown in FIG. 1, the embodiment comprises the following steps.

At step 101, a gesture operation event to a current screen is monitored.

At step 102, a desktop management menu is displayed when a first designated event is monitored. The desktop management menu comprises thumbnails of all screens of the desktop.

At step 103, an operation object of the first designated event and a screen corresponding to a target thumbnail of a second designated event in the desktop management menu are processed when the second designated event is monitored.

Optionally, displaying a desktop management menu which comprises thumbnails of all screens of the desktop when a first designated event is monitored comprises:
when the first designated event is monitored, retrieving data of all screens of the desktop from a desktop management database, generating a thumbnail of each of the screens correspondingly according to the data of all screens of the desktop, and displaying the desktop management menu which comprises thumbnails of all screens of the desktop.

Optionally, processing an operation object of the first designated event and a screen corresponding to a target thumbnail of a second designated event in the desktop management menu according to the second designated event when the second designated event is monitored comprises:
recording icon information of at least one icon in the current screen when the second designated event is monitored and the operation object of the first designated event is the at least one icon;
rendering the at least one icon as a user's finger moves according to moving coordinates of the user's finger and the icon information of the at least one icon; and
adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

Optionally, the method further comprises:
calculating remaining space of the screen corresponding to the first thumbnail when the moving coordinates of the user's finger enter the range of the first thumbnail while the at least one icon is rendered as the user's finger moves;
determining whether the screen corresponding to the first thumbnail has enough remaining space to accommodate the at least one icon according to the remaining space and a number of the at least one icon; and
displaying a first color in the range of the first thumbnail if it is the case, and displaying a second color in the range of the first thumbnail if it is not the case.

Optionally, the method further comprises:
calculating remaining space of the screen corresponding to each thumbnail in the desktop management menu when the second designated event is monitored;
determining whether the screen corresponding to each thumbnail has enough remaining space to accommodate the at least one icon according to the remaining space of the each thumbnail and a number of the at least one icon;
displaying a first color in the range of thumbnails corresponding to the screens having enough remaining space to accommodate the at least one icon if it is the case; and
displaying a second color in the range of thumbnails corresponding to the screens having insufficient remaining space to accommodate the at least one icon if it is not the case.

Optionally, adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail comprises:
determining whether a first thumbnail, which is any one thumbnail in the desktop management menu, has enough remaining space to accommodate the at least one icon when it is monitored that the second designated event is ended and the moving coordinates of the user's finger in the second designated event enter the range of the first thumbnail, and adding the at least one icon into the screen corresponding to the first thumbnail according to the recorded icon information of the at least one icon if it is the case.

Optionally, the method further comprises:
recovering the at least one icon in an original screen of the at least one icon when the first thumbnail does not have enough remaining space to accommodate the at least one icon.

Optionally, the first designated event is a long-press event to the at least one icon, and the second designated event is a drag event to the at least one icon.

Optionally, displaying a desktop management menu which comprises thumbnails of all screens of the desktop when a first designated event is monitored comprises:
switching the current screen into a drag and drop mode when the first designated event is monitored.

Optionally, processing an operation object of the first designated event and a screen corresponding to a target thumbnail of a second designated event in the desktop management menu according to the second designated event when the second designated event is monitored comprises:
acquiring clicking coordinates of the user's finger in the second designated event when the second designated event is monitored and the operation object of the first designated event is the current screen;
the thumbnail in the desktop management menu in which the clicking coordinates are located being the target thumbnail of the second designated event; and
switching the current screen to the screen in the desktop management menu corresponding to the target thumbnail.

Optionally, switching the current screen to the screen in the desktop management menu corresponding to the target thumbnail comprises:
acquiring an index number of the screen corresponding to the target thumbnail; and
switching the current screen to the screen in the desktop management menu corresponding to the target thumbnail according to the index number of the screen corresponding to the target thumbnail.

Optionally, the first designated event is a slide event in which the user's finger slides upwardly by a distance long than or equal to a designated distance, and the second designated event is a clicking event.

Optionally, processing an operation object of the first designated event and a screen corresponding to a target thumbnail of a second designated event in the desktop management menu according to the second designated event when the second designated event is monitored comprises:
recording information of a second thumbnail in the desktop management menu when the second designated event is monitored, the operation object of the first designated event is the current screen, and the operation object of the second designated event is the second thumbnail;
rendering the second thumbnail as the user's finger moves according to the moving coordinates of the user's finger in the second designated event and the information of the second thumbnail; and
modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

Optionally, modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail comprises:
when it is monitored that the second designated event is ended, calculating an overlapped area between the second thumbnail and the third thumbnail according to the moving coordinates of the user's finger when the second designated event is ended, wherein, if the overlapped area is larger than a preset value, it is determined that the the moving coordinates of the user's finger in the second designated event enter the range of the third thumbnail;
switching the location of the second thumbnail to the location of the third thumbnail in the desktop management menu, and switching the location of the third thumbnail to the original location of the second thumbnail or moving the locations of the third thumbnail and thumbnails following the third thumbnail sequentially in the rearward direction according to the information of the second thumbnail and the information of the third thumbnail.

Optionally, the method further comprises:
switching the desktop management menu into a drag and drop mode when the second designated event is monitored, the operation object of the first designated event is the current screen and the operation object of the second designated event is the second thumbnail in the desktop management menu.

Optionally, the first designated event is a slide event in which the user's finger slides upwardly by a distance longer than or equal to a designated distance, and the second designated event is a long-press and drag event to the second thumbnail.

Optionally, after processing an operation object of the first designated event and a screen corresponding to a target thumbnail of a second designated event in the desktop management menu according to the second designated event when the second designated event is monitored, the method further comprising:
updating data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

Optionally, after processing an operation object of the first designated event and a screen corresponding to a target thumbnail of a second designated event in the desktop management menu according to the second designated event when the second designated event is monitored, the method further comprising:
contracting the desktop management menu; or
contracting the desktop management menu when a third designated event is received.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient.

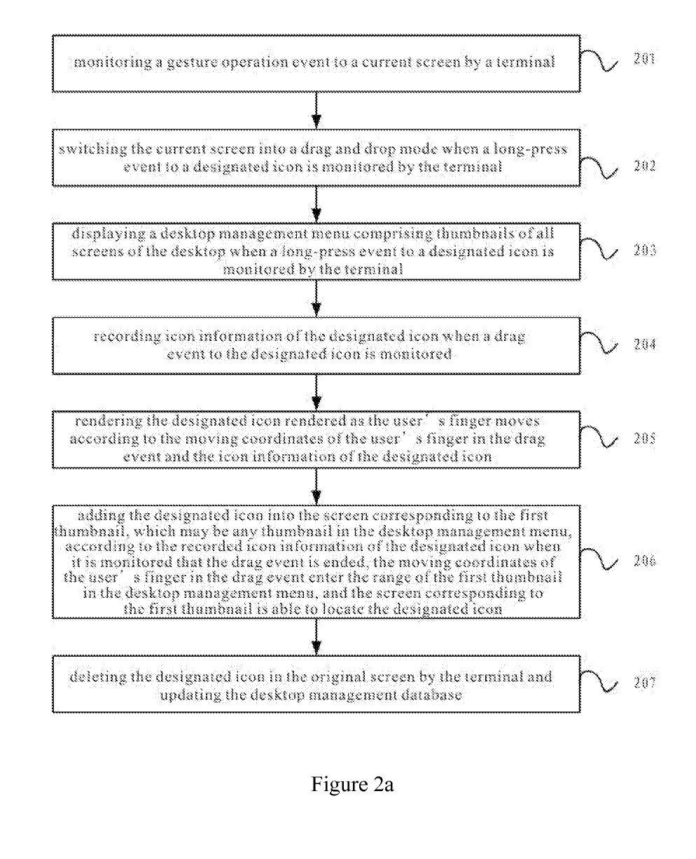

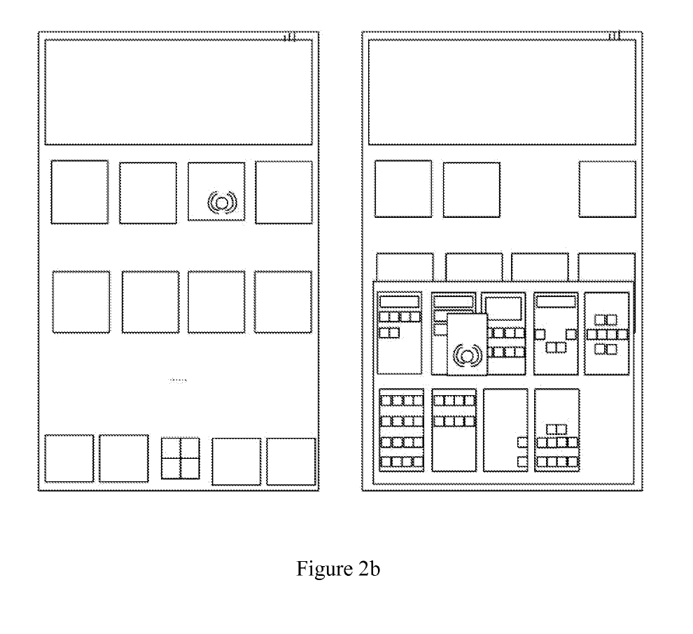

FIG. 2a is a flowchart of a method for desktop management according to an embodiment of the disclosure. The subject to perform the embodiment is a terminal device with touch-screen functions. For the convenience of description, the embodiment is described taken a situation in which a designated icon is moved under a desktop mode as an example. As shown in FIG. 2a, the embodiment comprises the following steps.

At step 201, a gesture operation event to a current screen is monitored by a terminal.

The gesture operation event is an event triggered by an operation of a user to the screen. The user's operation includes, but is not limited to, click, long-press, slide, drag, etc. Correspondingly, the gesture operation event includes, but is not limited to, a click event, a long-press event, a slide event, a drag event, etc. The gesture operation event is triggered by a figure on the screen, wherein the long-press event is triggered by a press operation to a certain target (a file icon or an application icon) exceeding a preset time period. Preferably, the preset time period is 500 ms.

At step 202, when a long-press event to a designated icon is monitored by the terminal, the current screen is switched into a drag and drop mode.

The designated icon may present an identifier of application software, a function or a file.

In this embodiment, taken the long-press event being the first designated event as an example, the long-press event is triggered by a designated icon being pressed by the user exceeding the preset time period. When the long-press event is monitored by the terminal, the current screen is switched into the drag and drop mode.

It is understood for a skilled in the art that, in the drag and drop mode, users can perform operations such as drag and drop to icons in the screen.

At step 203, when a long-press event to a designated icon is monitored by the terminal, a desktop management menu comprises thumbnails of all screens of the desktop is displayed.

In this embodiment, when the terminal enters the drag and drop mode, the desktop management menu is initiated and displayed, wherein the desktop management menu comprises thumbnails of all screens of the desktop.

For the step 203, when the first designated event is monitored, data of all screen of the desktop is retrieved from a desktop management database. The thumbnail of each screen is generated according to the data of all screen of the desktop, and then the desktop management menu comprising thumbnails of all screens of the desktop is displayed.

Since each thumbnail is generated according to data in the desktop management database, thumbnails in the desktop management menu are displayed in a same sequence as the screens of the terminal displayed in the desktop. The icons in each thumbnail in the desktop management menu are also displayed in a same sequence as the icons displayed in the screen.

It is noted that the size of the desktop management menu is less than the size of the screen. The size of the desktop management menu may be set by a technician at the development stage or by a terminal user according to his/her own usage preference.

At step 204, when a drag event to the designated icon is monitored, icon information of the designated icon is recorded.

In this embodiment, taken the drag event being the second designated event as an example, the object of the long-press event is the designated icon in the current screen. Thus, when a drag event to the designated icon is monitored, the icon information of the designated icon is recorded.

Specifically, the icon information includes information regarding the original screen the icon being located in, position coordinates of the icon in the original screen, and information regarding the icon itself, such as the icon ID, the icon path, etc.

At step 205, the designated icon is rendered as the user's finger moves according to the moving coordinates of the user's finger in the drag event and the icon information of the designated icon.

In this embodiment, in order to present the icon moving with the drag of the finger vividly, the designated icon is rendered, according to the moving coordinates of the user's finger in the drag event and the icon information of the designated icon, at the contact point of the finger with the movement of the finger.

Further, while at least one icon is rendered as the user's finger moves, remaining space of a screen corresponding to a first thumbnail is calculated when the moving coordinates of the user's finger enter a range of the first thumbnail in the desktop management menu. It is determined whether the screen corresponding to the first thumbnail has enough space to accommodate the icon. If it is the case, a first color is displayed in the range of the first thumbnail. Otherwise, a second color is displayed in the range of the first thumbnail.

For the convenience for knowing actual occupancy condition of each screen, when the moving coordinates of the user's finger enter a range of any thumbnail, the remaining space of the screen corresponding to the thumbnail is calculated. Specifically, the remaining space of the screen corresponding to the thumbnail may be calculated as follows. The number of idle icon positions in the screen can be obtained according to the number of icons which can be contained in the screen corresponding to the thumbnail and the number of icons existing in the screen. The number of idle icon positions is the remaining space of the screen corresponding to the thumbnail. It is noted that the number of idle icon positions may also be calculated from data in the desktop management database regarding the screen corresponding to the thumbnail, the description of which is omitted here.

Further, in order to provide a prompt to the user, it is possible to determine whether the screen corresponding to the thumbnail has enough idle icon positions to accommodate the icon according to the remaining space and the number of icons corresponding to the drag event. If the screen corresponding to the thumbnail is able to accommodate the icon, a first color is displayed in the range of the first thumbnail. If the screen corresponding to the thumbnail is unable to accommodate the icon, a second color other than the first color is displayed in the range of the first thumbnail. Specific colors to be used may be set by a technician at the development stage or by a terminal user according to his/her own usage preference.

It is noted that, in another embodiment, the step of calculating remaining space and displaying a color in this embodiment may be replaced by the following steps. When the second designated event (the drag event) is monitored, the remaining space of the screen corresponding to each thumbnail in the desktop management menu is calculated, and it is determined for the screen corresponding to each thumbnail whether it is able to accommodate the designated icon. If it is the case, a first color is displayed in a range of thumbnails corresponding to the screens being able to accommodate the designated icon. If it is not the case, a second color is displayed in a range of thumbnails corresponding to the screens being unable to accommodate the designated icon. The step for calculating remaining space and displaying a color in said another embodiment is different from that in the present embodiment in that the remaining space of each screen is calculated and a color indicating the remaining space is displayed in the corresponding thumbnail.

By calculating and displaying the remaining space, the terminal user can be informed whether each screen is able to accommodate the icon during the movement of the icon and be able to select the screen to accommodate the icon. Accordingly, a prompt is provided to the user by a direct visual effect, which avoids reviewing each of the screens and simplifies the operation process.

At step 206, when it is monitored that the drag event is ended, the moving coordinates of the user's finger in the drag event enter the range of the first thumbnail in the desktop management menu, and the screen corresponding to the first thumbnail is able to accommodate the designated icon, the designated icon is added into the screen corresponding to the first thumbnail according to the recorded icon information of the designated icon, wherein the first thumbnail may be any thumbnail in the desktop management menu.

When the user's finger leaves the terminal and becomes out of touch with the terminal, it is monitored that the drag event is ended.

In the embodiment, the drag event is considered to be ended when the moving coordinates of the user's finger enter the range of the first thumbnail as an example, wherein the first thumbnail may be any thumbnail.

Further, when the first thumbnail is unable to accommodate the designated icon, the designated icon is recovered in the original screen of the designated screen. Specifically, if the number of idle icon positions in the screen corresponding to the first thumbnail is less than the number of the designated icons when it is monitored by the terminal that the drag event is ended, the designated icons are recovered in the original screen of the designated icons, and the screen is not switched. In this embodiment, since only one icon is dragged in the drag event, the number of idle icon positions in the screen corresponding to the first thumbnail being less than the number of the designated icons means that there is no idle icon position in the screen corresponding to the first thumbnail.

At step 207, the designated icon in the original screen is deleted by the terminal and the desktop management database is updated.

The step 207 is a process for updating the data in the desktop management database regarding the operation object of the first designated event and/or the screen corresponding to the target thumbnail of the second designated event in the desktop management menu according to the process to the operation object of the first designated event and/or the screen corresponding to the target thumbnail of the second designated event in the desktop management menu.

Further, in order to facilitate the user to review the drag result of the icon, the terminal switches the current screen to the screen corresponding to the first thumbnail after the designated icon is added in to the screen corresponding to the first thumbnail.

Further, the terminal contracts the desktop management menu.

Optionally, this step may be implemented by contracting the desktop management menu when a third designated event is received. The third designated event may be a slide event in which the user's finger slides downward by a distance longer than or equal to a designated distance or other instructions for contracting the desktop management menu.

For example, FIG. 2b is a schematic diagram of a method for desktop management according to an embodiment of the disclosure. As shown in FIG. 2b, the icon marked in FIG. 2b is the designated icon. The page shown in the lower portion of the right drawing in FIG. 2b is the desktop management menu. The right drawing in FIG. 2b is a schematic diagram showing that the designated icon moves into a range of a thumbnail in the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient. Further, in the desktop state, the designated icon is moved to the thumbnail in the desktop management menu by using the display of the desktop management menu so that the designated is moved to the screen corresponding to the thumbnail without switching the screens sequentially as in the prior art which results in a long holding time of the icon and low operation efficiency.

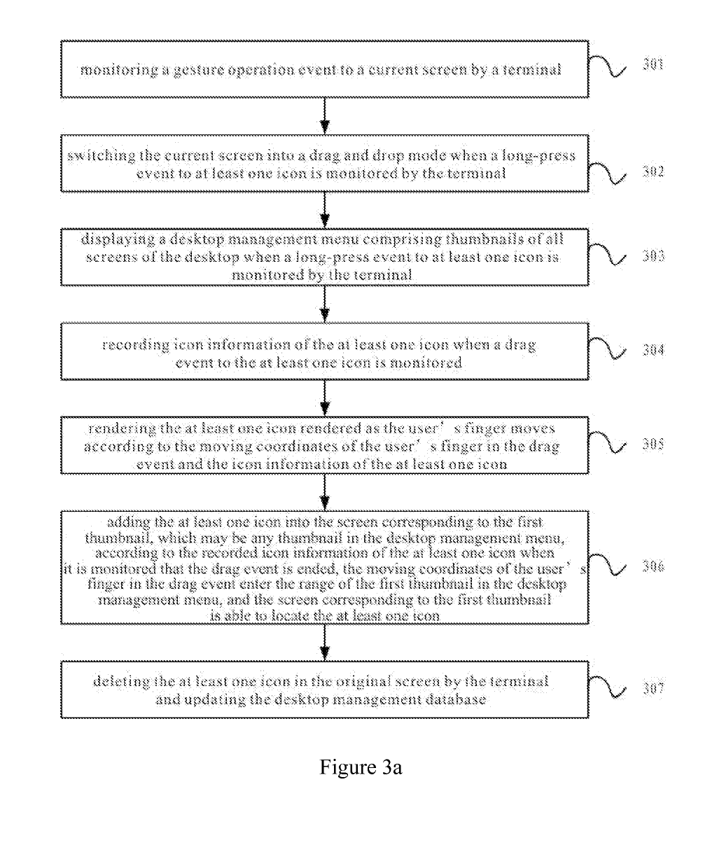

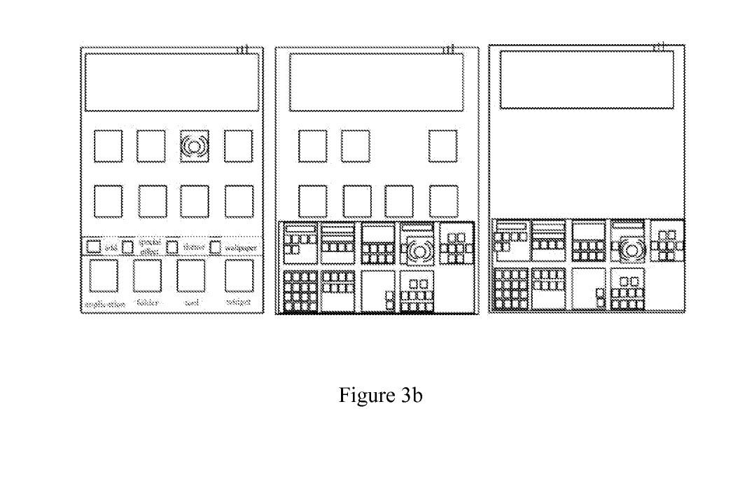

FIG. 3a is a flowchart of a method for desktop management according to an embodiment of the disclosure. The subject to perform the embodiment is a terminal device with touch-screen functions. For the convenience of description, the embodiment is described taken a situation in which at least one icon is moved under an edit mode as an example. This embodiment differs from that of FIG. 2a in that the icon to be moved in this embodiment may be one or more icons. As shown in FIG. 3a, the embodiment comprises the following steps.

At step 301, a gesture operation event to a current screen is monitored by a terminal.

At step 302, when a long-press event to a designated icon is monitored by the terminal, the current screen is switched into a drag and drop mode.

In this embodiment, taken the long-press event to at least one icon being the first designated event as an example, the long-press event to at least one icon may be triggered by to at least one icon being selected by the user under the edit mode and any of the at least one icon being long-pressed by the user after the selection of at least one icon is confirmed by a click.

At step 303, when a long-press event to the at least one icon is monitored by the terminal, a desktop management menu comprises thumbnails of all screens of the desktop is displayed.

At step 304, when a drag event to the at least one icon is monitored, icon information of the at least one icon is recorded.

At step 305, the designated icon is rendered as the user's finger moves according to the moving coordinates of the user's finger in the drag event and the icon information of the at least one icon.

The above steps 301-305 are similar to the steps 201-205. The steps 201-205 are described taking one designated icon as an example, while the steps 301-305 are described taking at least one icon (one or more icons) as an example. The detailed description of the steps 301-305 is omitted here.

Further, while at least one icon is rendered as the user's finger moves, remaining space of a screen corresponding to a first thumbnail is calculated when the moving coordinates of the user's finger enter a range of the first thumbnail in the desktop management menu. It is determined whether the screen corresponding to the first thumbnail has enough space to accommodate the at least one icon. If it is the case, a first color is displayed in the range of the first thumbnail. Otherwise, a second color is displayed in the range of the first thumbnail.

For the convenience for knowing actual occupancy condition of each screen, when the moving coordinates of the user's finger enter a range of any thumbnail, the remaining space of the screen corresponding to the thumbnail for receiving icons is calculated. Specifically, the remaining space of the screen corresponding to the thumbnail for receiving icons may be calculated as follows. The number of idle icon positions in the screen can be obtained according to the number of icons which can be contained in the screen corresponding to the thumbnail and the number of icons existing in the screen. The number of idle icon positions is the remaining space of the screen corresponding to the thumbnail. It is noted that the number of idle icon positions may also be calculated from data in the desktop management database regarding the screen corresponding to the thumbnail, the description of which is omitted here.

Further, in order to provide a prompt to the user, it is possible to determine whether the screen corresponding to the thumbnail has enough idle icon positions to accommodate the at least one icon according to the remaining space and the number of icons corresponding to the drag event. If the number of idle icon positions in the screen corresponding to the thumbnail is larger than or equal to the number of icons in the drag event, it is determined that the screen corresponding to the thumbnail is able to accommodate the at least one icon, and a first color is displayed in the range of the first thumbnail. If the number of idle icon positions in the screen corresponding to the thumbnail is less than the number of icons in the drag event, it is determined that the screen corresponding to the thumbnail is unable to accommodate the icon, a second color other than the first color is displayed in the range of the first thumbnail. Specific colors to be used may be set by a technician at the development stage or by a terminal user according to his/her own usage preference.

It is noted that, in another embodiment, the step of calculating remaining space and displaying a color in this embodiment may be replaced by the following steps. When the second designated event (the drag event) is monitored, the remaining space of the screen corresponding to each thumbnail in the desktop management menu is calculated, and it is determined for the screen corresponding to each thumbnail whether it is able to accommodate said at least one icon. If it is the case, a first color is displayed in a range of thumbnails corresponding to the screens being able to accommodate the at least one icon. If it is not the case, a second color is displayed in a range of thumbnails corresponding to the screens being unable to accommodate the at least one icon. The step for calculating remaining space and displaying a color in said another embodiment is different from that in the present embodiment in that the remaining space of each screen is calculated and a color indicating the remaining space is displayed in the corresponding thumbnail.

By calculating and displaying the remaining space, the terminal user can be informed whether each screen is able to accommodate the at least one icon during the movement of the icon and be able to select the screen to accommodate the icon. Accordingly, a prompt is provided to the user by a direct visual effect, which avoids reviewing each of the screens and simplifies the operation process.

At step 306, when it is monitored that the drag event is ended, the moving coordinates of the user's finger in the drag event enter the range of the first thumbnail in the desktop management menu, and the screen corresponding to the first thumbnail is able to accommodate the designated icon, the at least one icon is added into the screen corresponding to the first thumbnail according to the recorded icon information of the at least one icon, wherein the first thumbnail may be any thumbnail in the desktop management menu.

When the user's finger leaves the terminal and becomes out of touch with the terminal, it is monitored that the drag event is ended.

In the embodiment, the drag event is considered to be ended when the moving coordinates of the user's finger enter the range of the first thumbnail as an example, wherein the first thumbnail may be any thumbnail.

Further, when the first thumbnail is unable to accommodate the designated icon, the designated icon is recovered in the original screen of the designated screen.

Specifically, if the number of idle icon positions in the screen corresponding to the first thumbnail is less than the number of the at least one icon when it is monitored by the terminal that the drag event is ended, the at least one icon is recovered in the original screen of the designated icons, and the screen is not switched. In this embodiment, at least one icon is dragged in the drag event. In another embodiment, if the number of idle icon positions in the screen corresponding to the first thumbnail is less than the number of the designated icons when it is monitored by the terminal that the drag event is ended, icons of the number equal to that of the idle icon positions among the at least one icon may be added to the idle icon positions in the screen corresponding to the first thumbnail, icons that have not been added are recovered in the original screen of the at least one icon, and the screen is not switched. It may be set by a technician at the development stage or by a terminal user according to his/her own usage preference whether the screen is switched or not.

At step 307, the designated icon in the original screen is deleted by the terminal and the desktop management database is updated.

Further, in order to facilitate the user to review the drag result of the icon, the terminal switches the current screen to the screen corresponding to the first thumbnail after the at least one icon is added in to the screen corresponding to the first thumbnail.

Further, the terminal contracts the desktop management menu.

Optionally, this step may be implemented by contracting the desktop management menu when a third designated event is received. The third designated event may be a slide event in which the user's finger slides downward by a distance longer than or equal to a designated distance or other instructions for contracting the desktop management menu.

For example, FIG. 3b is a schematic diagram of a method for desktop management according to an embodiment of the disclosure. As shown in FIG. 3b, the icon marked in the left drawing in FIG. 3b is any of the at least one icon. The middle drawing in FIG. 3b is schematic diagram showing that one icon moves into a range of a thumbnail in the desktop management menu. The right drawing in FIG. 3b is a schematic diagram showing that at least one icon moves into a range of a thumbnail in the desktop management menu. The pages shown in the lower portions of the middle and right drawings in FIG. 3b are the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient. Further, in the edit state, the at least one icon is moved to the thumbnail in the desktop management menu by using the display of the desktop management menu so that the designated is moved to the screen corresponding to the thumbnail without switching the screens sequentially as in the prior art which results in a long holding time of the icon and low operation efficiency.

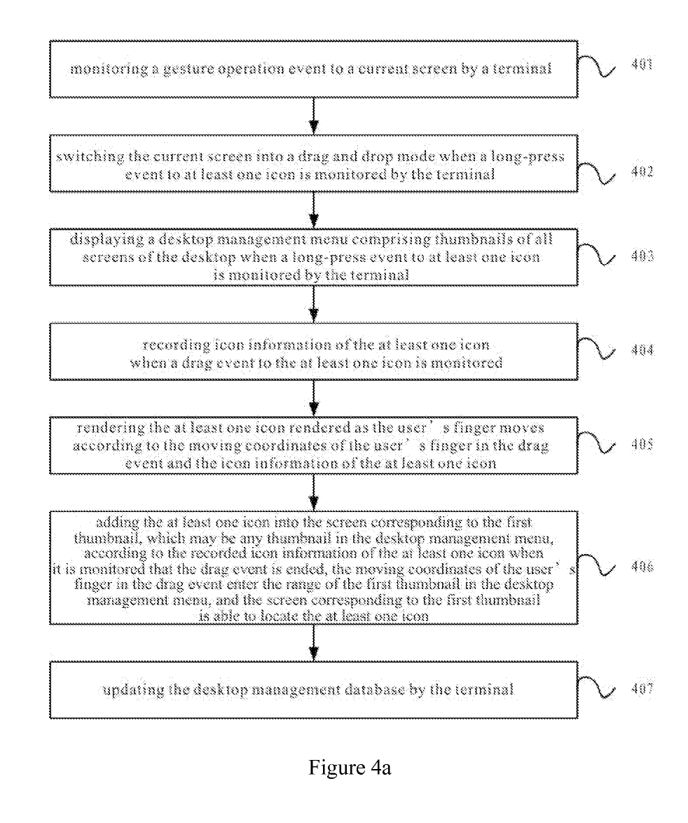

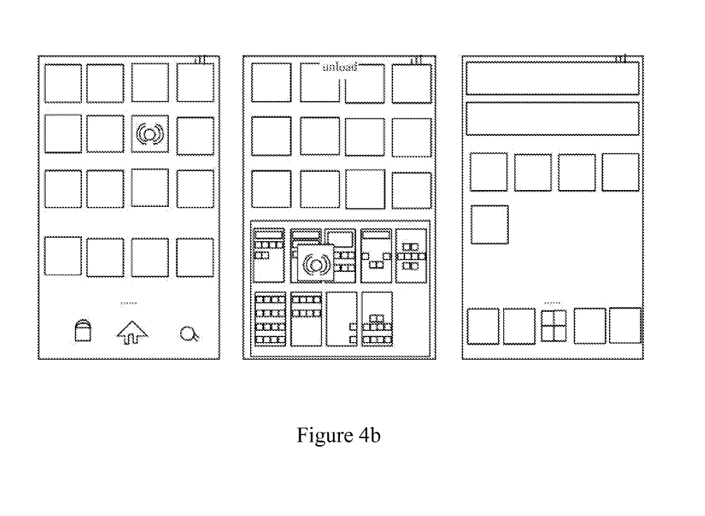

FIG. 4a is a flowchart of a method for desktop management according to an embodiment of the disclosure. The subject to perform the embodiment is a terminal device with touch-screen functions. For the convenience of description, the embodiment is described taken a situation in which at least one icon is moved under an edit mode as an example. This embodiment differs from that of FIG. 2a in that the icon to be moved is not deleted from the application management page even it is successfully moved. As shown in FIG. 4a, the embodiment comprises the following steps.

At step 401, a gesture operation event to a current screen is monitored by a terminal.

Before the step 401, the terminal is switched to an application management page or initiates an application manager. The application management page includes icons of application programs built in the system and icons of application programs installed by the user.

At step 402, when a long-press event to a designated icon is monitored by the terminal, the current screen is switched into a drag and drop mode.

In this embodiment, taken the long-press event to at least one icon being the first designated event as an example, the long-press event to at least one icon may be triggered by to at least one icon in the application management page being selected by the user and any of the at least one icon in the application management page being long-pressed by the user after the selection of at least one icon is confirmed by a click.

At step 403, when a long-press event to the at least one icon is monitored by the terminal, a desktop management menu comprises thumbnails of all screens of the desktop is displayed.

At step 404, when a drag event to the at least one icon is monitored, icon information of the at least one icon is recorded.

At step 405, the designated icon is rendered as the user's finger moves according to the moving coordinates of the user's finger in the drag event and the icon information of the at least one icon.

The above steps 401-405 are similar to the steps 301-305. The detailed description of the steps 401-405 is omitted here.

Further, while at least one icon is rendered as the user's finger moves, remaining space of a screen corresponding to a first thumbnail is calculated when the moving coordinates of the user's finger enter a range of the first thumbnail in the desktop management menu. It is determined whether the screen corresponding to the first thumbnail has enough space to accommodate the at least one icon. If it is the case, a first color is displayed in the range of the first thumbnail. Otherwise, a second color is displayed in the range of the first thumbnail.

For the convenience for knowing actual occupancy condition of each screen, when the moving coordinates of the user's finger enter a range of any thumbnail, the remaining space of the screen corresponding to the thumbnail is calculated. Specifically, the remaining space of the screen corresponding to the thumbnail may be calculated as follows. The number of idle icon positions in the screen can be obtained according to the number of icons which can be contained in the screen corresponding to the thumbnail and the number of icons existing in the screen. The number of idle icon positions is the remaining space of the screen corresponding to the thumbnail. It is noted that the number of idle icon positions may also be calculated from data in the desktop management database regarding the screen corresponding to the thumbnail, the description of which is omitted here.

Further, in order to provide a prompt to the user, it is possible to determine whether the screen corresponding to the thumbnail has enough idle icon positions to accommodate the at least one icon according to the remaining space and the number of icons corresponding to the drag event. If the number of idle icon positions in the screen corresponding to the thumbnail is larger than or equal to the number of icons in the drag event, it is determined that the screen corresponding to the thumbnail is able to accommodate the at least one icon, and a first color is displayed in the range of the first thumbnail. If the number of idle icon positions in the screen corresponding to the thumbnail is less than the number of icons in the drag event, it is determined that the screen corresponding to the thumbnail is unable to accommodate the icon, a second color other than the first color is displayed in the range of the first thumbnail. Specific colors to be used may be set by a technician at the development stage or by a terminal user according to his/her own usage preference.

It is noted that, in another embodiment, the step of calculating remaining space and displaying a color in this embodiment may be replaced by the following steps. When the second designated event (the drag event) is monitored, the remaining space of the screen corresponding to each thumbnail in the desktop management menu is calculated, and it is determined for the screen corresponding to each thumbnail whether it is able to accommodate said at least one icon. If it is the case, a first color is displayed in a range of thumbnails corresponding to the screens being able to accommodate the at least one icon. If it is not the case, a second color is displayed in a range of thumbnails corresponding to the screens being unable to accommodate the at least one icon. The step for calculating remaining space and displaying a color in said another embodiment is different from that in the present embodiment in that the remaining space of each screen is calculated and a color indicating the remaining space is displayed in the corresponding thumbnail.

By calculating and displaying the remaining space, the terminal user can be informed whether each screen is able to accommodate the at least one icon during the movement of the icon and be able to select the screen to accommodate the icon. Accordingly, a prompt is provided to the user by a direct visual effect, which avoids reviewing each of the screens and simplifies the operation process.

At step 406, when it is monitored that the drag event is ended, the moving coordinates of the user's finger in the drag event enter the range of the first thumbnail in the desktop management menu, and the screen corresponding to the first thumbnail is able to accommodate the designated icon, the at least one icon is added into the screen corresponding to the first thumbnail according to the recorded icon information of the at least one icon, wherein the first thumbnail may be any thumbnail in the desktop management menu.

When the user's finger leaves the terminal and becomes out of touch with the terminal, it is monitored that the drag event is ended.

In the embodiment, the drag event is considered to be ended when the moving coordinates of the user's finger enter the range of the first thumbnail as an example, wherein the first thumbnail may be any thumbnail.

Further, when the first thumbnail is unable to accommodate the designated icon, the designated icon is recovered in the original screen of the designated screen.

Specifically, if the number of idle icon positions in the screen corresponding to the first thumbnail is less than the number of the at least one icon when it is monitored by the terminal that the drag event is ended, the at least one icon is recovered in the original screen of the designated icons, and the screen is not switched. In this embodiment, at least one icon is dragged in the drag event. In another embodiment, if the number of idle icon positions in the screen corresponding to the first thumbnail is less than the number of the designated icons when it is monitored by the terminal that the drag event is ended, icons of the number equal to that of the idle icon positions among the at least one icon may be added to the idle icon positions in the screen corresponding to the first thumbnail, icons that have not been added are recovered in the original screen of the at least one icon, and the screen is not switched. It may be set by a technician at the development stage or by a terminal user according to his/her own usage preference whether the screen is switched or not.

At step 407, the desktop management database is updated by the terminal.

In this embodiment, the terminal deletes the at least one icon in the application management page. The terminal only updates the at least one icon to the screen corresponding to the first thumbnail when updating the desktop management database.

Further, in order to facilitate the user to review the drag result of the icon, the terminal switches the current screen to the screen corresponding to the first thumbnail after the at least one icon is added in to the screen corresponding to the first thumbnail.

Further, the terminal contracts the desktop management menu.

Optionally, this step may be implemented by contracting the desktop management menu when a third designated event is received. The third designated event may be a slide event in which the user's finger slides downward by a distance longer than or equal to a designated distance or other instructions for contracting the desktop management menu.

For example, FIG. 4b is a schematic diagram of a method for desktop management according to an embodiment of the disclosure. As shown in FIG. 3b, the icon marked in FIG. 4b is the icon to be added to the screen. The middle drawing in FIG. 4b is schematic diagram showing that an icon in the application management page moves into a range of a thumbnail in the desktop management menu. The right drawing in FIG. 4b is a schematic diagram after the movement. The page shown in the lower portion of the middle drawing in FIG. 4b is the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient. Further, in the application management page, the at least one icon is moved to the thumbnail in the desktop management menu by using the display of the desktop management menu so that the designated is moved to the screen corresponding to the thumbnail without switching the screens sequentially as in the prior art which results in a long holding time of the icon and low operation efficiency.

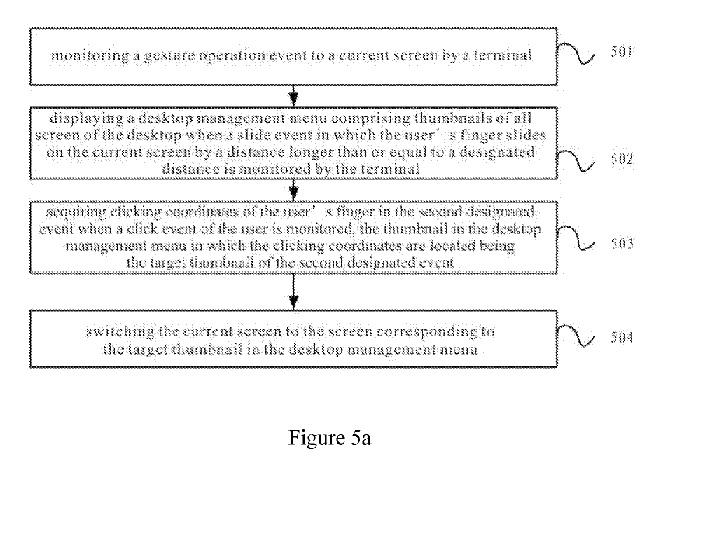

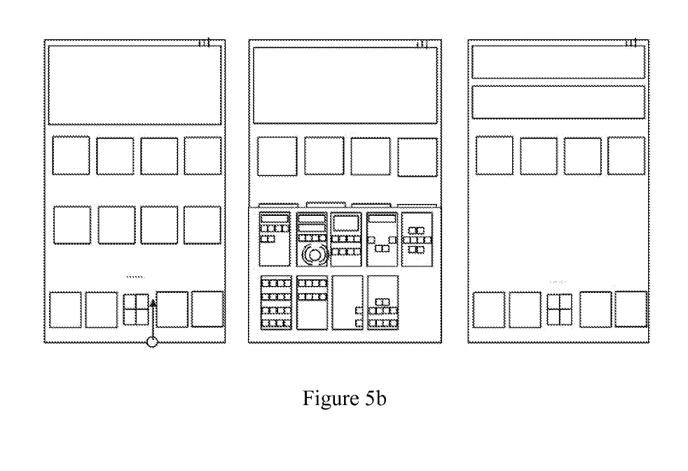

FIG. 5a is a flowchart of a method for desktop management according to an embodiment of the disclosure. The subject to perform the embodiment is a terminal device with touch-screen functions. For the convenience of description, the embodiment is described taken a situation in which the currently displayed screen is switched as an example. As shown in FIG. 5a, the embodiment comprises the following steps.

At step 501, a gesture operation event to a current screen is monitored by a terminal.

At step 502, when a slide event in which the user's finger slides on the current screen by a distance longer than or equal to a designated distance is monitored by the terminal, the desktop management menu comprising thumbnails of all screen of the desktop is displayed.

In this embodiment, a slide event in which the user's finger slides on the current screen by a distance longer than or equal to a designated distance is taken as an example for the first designated event. The slide event may be set by a technician at the development stage or by a terminal user according to his/her own usage preference.

At step 503, when a click event of the user is monitored, clicking coordinates of the user's finger in the second designated event are acquired. The thumbnail in the desktop management menu in which the clicking coordinates are located is the target thumbnail of the second designated event.

In this embodiment, taking a click event being the second designated event as an example, when the clicking coordinates of the user's finger fall in a range of any thumbnail in the desktop management menu, the thumbnail is the target thumbnail of the second designated event, and the screen corresponding to the target thumbnail is the object screen for the current screen switching.

At step 504, the current screen is switched to the screen corresponding to the target thumbnail in the desktop management menu.

For the step 504, it is implemented by obtaining an index number of the screen corresponding to the target thumbnail, and switching the current screen to the screen corresponding to the target thumbnail in the desktop management menu according to the index number of the screen corresponding to the target thumbnail. The screen corresponding to each target thumbnail has a unique index number, from which the object screen to be switched is determined and then the current screen is switched to the screen corresponding to the target thumbnail in the desktop management menu.

Further, the terminal contracts the desktop management menu.

Optionally, this step may be implemented by contracting the desktop management menu when a third designated event is received. The third designated event may be a desktop management menu contraction instruction.

For example, FIG. 5b is a schematic diagram of a method for desktop management according to an embodiment of the disclosure. As shown in FIG. 5b, the direction indicated by the arrow in the left drawing in FIG. 5b is the gesture operation for triggering the first designated event, the thumbnail marked in the middle drawing in FIG. 5b is the operation object of the second designated event, and the right drawing in FIG. 5b is a schematic diagram after the switch. The page shown in the lower portion of the middle drawing in FIG. 5b is the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient. Further, by displaying the desktop management menu and clicking the thumbnail of the object screen in the desktop management menu, the current screen is switched to the object screen, thus avoiding sequentially switching the screens as in the prior art which results in low operation efficiency.

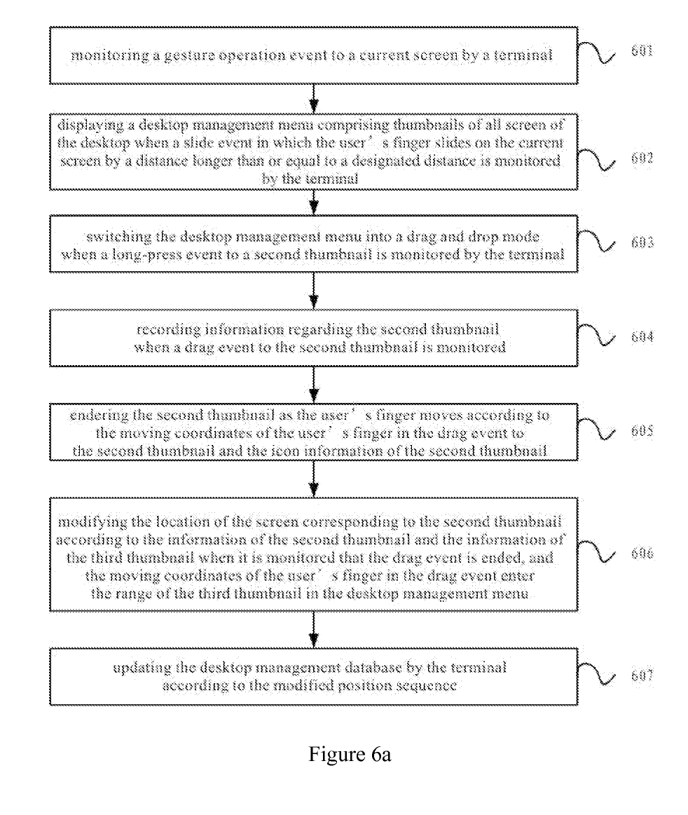

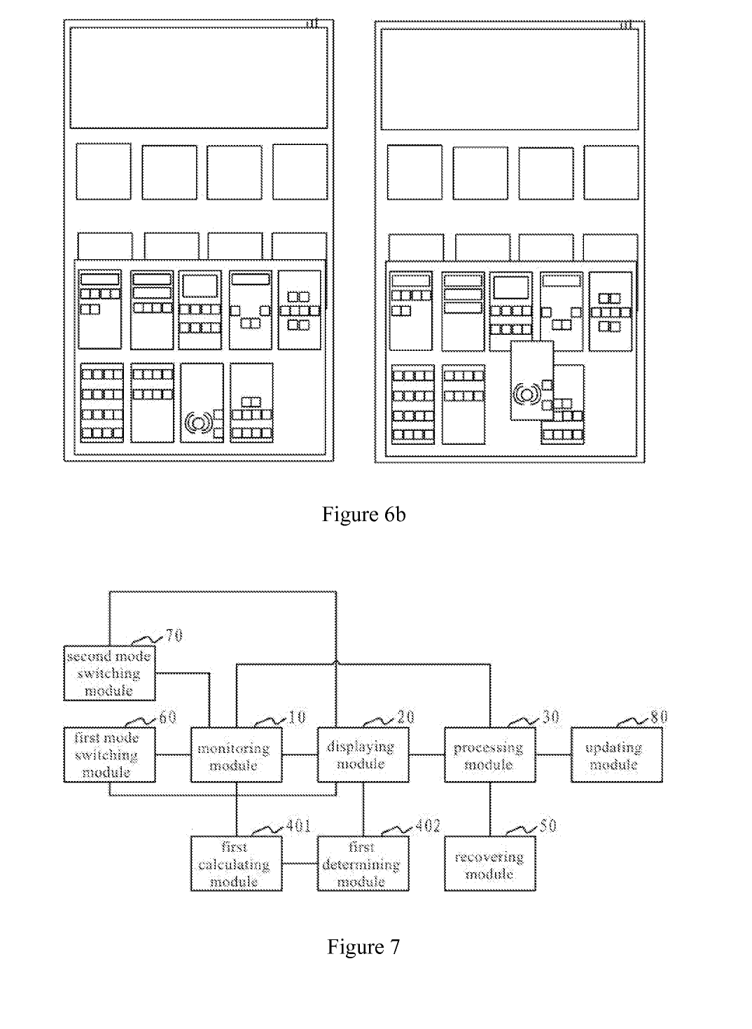

FIG. 6a is a flowchart of a method for desktop management according to an embodiment of the disclosure. The subject to perform the embodiment is a terminal device with touch-screen functions. For the convenience of description, the embodiment is described taken a situation in which the sequence of the screens is adjusted as an example. As shown in FIG. 6a, the embodiment comprises the following steps.

At step 601, a gesture operation event to a current screen is monitored by a terminal.

At step 602, when a slide event in which the user's finger slides on the current screen by a distance longer than or equal to a designated distance is monitored by the terminal, the desktop management menu comprising thumbnails of all screen of the desktop is displayed.

In this embodiment, a slide event in which the user's finger slides on the current screen by a distance longer than or equal to a designated distance is taken as an example for the first designated event. The slide event may be set by a technician at the development stage or by a terminal user according to his/her own usage preference.

At step 603, when a long-press event to a second thumbnail is monitored by the terminal, the desktop management menu is switched into a drag and drop mode.

It is noted that, in this embodiment, the second thumbnail means the operation object of the long-press event of the terminal and can be any thumbnail in the desktop management menu.

At step 604, when a drag event to the second thumbnail is monitored, information regarding the second thumbnail is recorded.

The information of the second thumbnail may be the index number corresponding to the thumbnail, the original position of the thumbnail in the desktop management menu, icons in the screen corresponding to the thumbnail, etc.

At step 605, the second thumbnail is rendered as the user's finger moves according to the moving coordinates of the user's finger in the drag event to the second thumbnail and the icon information of the second thumbnail.

The process for rendering is similar to that in the embodiments as shown in FIGS. 2-4 and thus is omitted here.

At step 606, when it is monitored that the drag event is ended, and the moving coordinates of the user's finger in the drag event enter the range of the third thumbnail in the desktop management menu, the location of the screen corresponding to the second thumbnail is modified according to the information of the second thumbnail and the information of the third thumbnail.

Specifically, when it is monitored that the drag event is ended, the overlapped area between the second thumbnail and the third thumbnail is calculated according to the moving coordinates of the user's finger when the drag event is ended. If the overlapped area is larger than or equal to a preset value, it is determined that the moving coordinates of the user's finger in the drag event enter the range of the third thumbnail in the desktop management menu.

It is noted that, for the adjustment of the screen sequence, in order to avoid the screen sequence being disordered, the object screen is considered to be confirmed by the user when the overlapped area between screens reaches a preset value. Thus, in this embodiment, the overlapped area between the second thumbnail and the third thumbnail is calculated. If the overlapped area is larger than or equal to a preset value, it is determined that the moving coordinates of the user's finger in the drag event enter the range of the third thumbnail in the desktop management menu.

According to the information of the second thumbnail and the information of the third thumbnail, the location of the second thumbnail in the desktop management menu is switched to that of the third thumbnail, and the location of the third thumbnail may be switched to that of the second thumbnail, or the third thumbnail and each of the following thumbnails are sequentially moved in the rearward direction.

In this embodiment, when the location of the second thumbnail in the desktop management menu is switched to that of the third thumbnail, the third thumbnail may be processed in two manners, i.e., the location of the third thumbnail may be switched to that of the second thumbnail, or the third thumbnail and each of the following thumbnails are sequentially moved in the rearward direction. The specific selection for the process manner may be set by a technician at the development stage or by a terminal user according to his/her own usage preference.

Further, if the overlapped area is larger than or equal to a preset value, it is determined that the moving coordinates of the user's finger in the drag event have not entered the range of the third thumbnail in the desktop management menu. In this case, no process is made to the third thumbnail and the location of the second thumbnail in the desktop management menu is recovered.

At step 607, the terminal updates the desktop management database according to the modified position sequence.

The specific updating process is prior art and thus is omitted here.

Optionally, this step may be implemented as follows. When a third designated event is received, the desktop management menu is contracted. The third designated event may be a slide event in which the user's finger slides downward by a distance longer than or equal to a designated distance or other instructions for contracting the desktop management menu.

For example, FIG. 6b is a schematic diagram of a method for desktop management according to an embodiment of the disclosure. As shown in FIG. 6b, the thumbnail marked in the left drawing in FIG. 6b is the operation object of the second designated event. The right drawing in FIG. 6b is a schematic diagram during the movement. The page shown in the lower portion of the middle drawing in FIG. 6b is the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient. Further, by displaying the desktop management menu and long-pressing and dragging the thumbnail of the screen in the desktop management menu, the thumbnail is moved and the position sequence of thumbnails of screens in the desktop management menu is adjusted, avoiding sequentially switching the screens as in the prior art which results in low operation efficiency.

FIG. 7 is a schematic structural block view of an apparatus for desktop management according to an embodiment of the disclosure. As shown in FIG. 7, the apparatus for desktop management comprises the following modules.

A monitoring module 10 is configured to monitor a gesture operation event to a current screen.

The gesture operation event is an event triggered by an operation of a user to the screen. The user's operation includes, but is not limited to, click, long-press, slide, drag, etc. Correspondingly, the gesture operation event includes, but is not limited to, a click event, a long-press event, a slide event, a drag event, etc. The gesture operation event is triggered by a figure on the screen, wherein the long-press event is triggered by a press operation to a certain target (a file icon or an application icon) exceeding a preset time period. Preferably, the preset time period is 500 ms.

A displaying module 20 is configured to display a desktop management menu comprises thumbnails of all screens of the desktop when a first designated event is monitored.

A processing module 30 is configured to process the process the operation object of the first designated event and the screen corresponding to the target thumbnail of a second designated event in the desktop management menu according to the second designated event when the second designated event is monitored.

Optionally, when the first designated event is monitored, the displaying module 20 retrieves data regarding all screens of the desktop from a desktop management database, generates thumbnails for each of the screens according to the data regarding all screens of the desktop, and displays the desktop management menu comprising thumbnails of all screens of the desktop.

Since each thumbnail is generated according to data in the desktop management database, thumbnails in the desktop management menu are displayed in a same sequence as the screens of the terminal displayed in the desktop. The icons in each thumbnail in the desktop management menu are also displayed in a same sequence as the icons displayed in the screen.

It is noted that the size of the desktop management menu is less than the size of the screen. The size of the desktop management menu may be set by a technician at the development stage or by a terminal user according to his/her own usage preference.

Optionally, the processing module 30 may comprises the following units.

A recording unit is configured to record icon information of at least one icon when the second designated event is monitored and the operation object of the first designated event is the at least one icon in the current screen.

Specifically, the icon information includes information regarding the original screen the icon being located in, position coordinates of the icon in the original screen, and information regarding the icon itself, such as the icon ID, the icon path, etc.

A rendering unit is configured to render the at least one icon as the user's finger moves according to the moving coordinates of the user's finger in the drag event and the icon information of the at least one icon.

A processing unit is configured to add the at least one icon into the screen corresponding to the first thumbnail according to the recorded icon information of the at least one icon when it is monitored that the drag event is ended and the moving coordinates of the user's finger in the drag event enter the range of the first thumbnail in the desktop management menu, wherein the first thumbnail may be any thumbnail in the desktop management menu.

Optionally, the apparatus further comprises the following modules.

A first calculating module 401 is configured to calculate the remaining space of the screen corresponding to the thumbnail when the moving coordinates of the user's finger enter a range of a first thumbnail in the desktop management menu during the user's finger is moving to render the at least one icon.

A first determining module 402 is configured to determine whether the screen corresponding to the thumbnail has enough idle icon positions to accommodate the at least one icon according to the remaining space and the number of at least one icon. If it is determined by the first determining module that the screen corresponding to the thumbnail is able to accommodate the at least one icon, the displaying module 20 is triggered to display a first color in the range of the first thumbnail. If it is determined by the first determining module that the screen corresponding to the thumbnail is unable to accommodate the at least one icon, the displaying module 20 is triggered to display a second color other than the first color in the range of the first thumbnail.

In this embodiment, in order to present the icon moving with the drag of the finger vividly, the designated icon is rendered, according to the moving coordinates of the user's finger in the drag event and the icon information of the designated icon, at the contact point of the finger with the movement of the finger.

Further, while at least one icon is rendered as the user's finger moves, remaining space of a screen corresponding to a first thumbnail is calculated when the moving coordinates of the user's finger enter a range of the first thumbnail in the desktop management menu. It is determined whether the screen corresponding to the first thumbnail has enough space to accommodate the icon. If it is the case, a first color is displayed in the range of the first thumbnail. Otherwise, a second color is displayed in the range of the first thumbnail.

For the convenience for knowing actual occupancy condition of each screen, when the moving coordinates of the user's finger enter a range of any thumbnail, the remaining space of the screen corresponding to the thumbnail is calculated. Specifically, the remaining space of the screen corresponding to the thumbnail may be calculated as follows. The number of idle icon positions in the screen can be obtained according to the number of icons which can be contained in the screen corresponding to the thumbnail and the number of icons existing in the screen. The number of idle icon positions is the remaining space of the screen corresponding to the thumbnail. It is noted that the number of idle icon positions may also be calculated from data in the desktop management database regarding the screen corresponding to the thumbnail, the description of which is omitted here.

Further, in order to provide a prompt to the user, it is possible to determine whether the screen corresponding to the thumbnail has enough idle icon positions to accommodate the icon according to the remaining space and the number of icons corresponding to the drag event. If the screen corresponding to the thumbnail is able to accommodate the icon, a first color is displayed in the range of the first thumbnail. If the screen corresponding to the thumbnail is unable to accommodate the icon, a second color other than the first color is displayed in the range of the first thumbnail. Specific colors to be used may be set by a technician at the development stage or by a terminal user according to his/her own usage preference.

Optionally, the apparatus may further comprise the following modules.

A second calculating module is configured to calculate the remaining space of the screen corresponding to each thumbnail in the desktop management menu when second designated event is monitored.

A second determining module is configured to determine whether the screen corresponding to each thumbnail has enough idle icon positions to accommodate the at least one icon according to the remaining space of the screen corresponding to each thumbnail and the number of at least one icon. If it is the case, the displaying module is triggered to display a first color in the range of the thumbnail corresponding to a screen which is able to accommodate the at least one icon. If not, the displaying module is triggered to display a second color other than the first color in the range of the thumbnail corresponding to a screen which is unable to accommodate the at least one icon.

Such step for calculating remaining space and displaying a color is different from that in the this embodiment in that, when the desktop management menu is displayed, the remaining space of each screen is calculated and a color indicating the remaining space is displayed in the corresponding thumbnail.

By calculating and displaying the remaining space, the terminal user can be informed whether each screen is able to accommodate the icon during the movement of the icon and be able to select the screen to accommodate the icon. Accordingly, a prompt is provided to the user by a direct visual effect, which avoids reviewing each of the screens and simplifies the operation process.

Optionally, the processing unit is configured to determine whether the first thumbnail is able to accommodate the at least one icon when it is monitored that the second designated event is ended and the moving coordinates of the user's finger in the second designated event enter the range of the first thumbnail in the desktop management menu. If it is the case, the at least one icon is added into the screen corresponding to the first thumbnail according to the recorded icon information of the at least one icon, wherein the first thumbnail may be any thumbnail in the desktop management menu.

Optionally, the apparatus may further comprise the following modules.

A recovering module 50 is configured to recover the at least one icon in the original screen of the at least one icon when the first thumbnail is unable to accommodate the at least one icon.

Specifically, if the number of idle icon positions in the screen corresponding to the first thumbnail is less than the number of the designated icons when it is monitored by the terminal that the drag event is ended, the designated icons are recovered in the original screen of the designated icons, and the screen is not switched. In this embodiment, since only one icon is dragged in the drag event, the number of idle icon positions in the screen corresponding to the first thumbnail being less than the number of the designated icons means that there is no idle icon position in the screen corresponding to the first thumbnail.

Optionally, the first designated event is a long-press event to at least one icon, and the second designated event is a drag event to the at least one icon.

Further, in order to facilitate the user to review the drag result of the icon, the terminal switches the current screen to the screen corresponding to the first thumbnail after the designated icon is added in to the screen corresponding to the first thumbnail.

Optionally, the apparatus may further comprise the following module.

A first mode switching module 60 is configured to switch the current screen to a drag and drop mode when a first designated event is monitored. In this embodiment, when the terminal is switched into a drag and drop mode, the desktop management menu is initiated and displayed in the current screen, wherein the desktop management menu includes thumbnails of all screen of the desktop.

Optionally, the processing module 30 comprises the following units.

An acquiring unit is configured to acquire the clicking coordinates of the user's finger in the second designated event when a second designated event is monitored and the operation object of the first designated event is the current screen. The thumbnail in the desktop management menu in which the clicking coordinates are located is the target thumbnail of the second designated event.

A switching unit is configured to switch the switch the current screen to the screen corresponding to the target thumbnail in the desktop management menu.

Optionally, the switching unit obtains an index number of the screen corresponding to the target thumbnail, and switches the current screen to the screen corresponding to the target thumbnail in the desktop management menu according to the index number of the screen corresponding to the target thumbnail.

Optionally, the first designated event may be a slide event in which the user's finger slides downward by a distance longer than or equal to a designated distance, and the second designated event is a clicking event.

Optionally, the processing module 30 may further comprise the following units.

A thumbnail information recording unit is configured to record information regarding the second thumbnail when the second designated event is monitored, the operation object of the first designated event is the current screen and the operation object of the second designated event is the second thumbnail in the desktop management menu.

A thumbnail rendering unit is configured to render the second thumbnail as the user's finger moves according to the moving coordinates of the user's finger in the second designated event and the information of the second thumbnail.

A modifying unit is configured to the location of the screen corresponding to the second thumbnail is modified according to the information of the second thumbnail and the information of the third thumbnail when the second designated event is ended and the moving coordinates of the user's finger enter a designated range of a third thumbnail in the desktop management menu.

Optionally, when it is monitored that the second designated event is ended, the modifying unit is configured to calculate the overlapped area between the second thumbnail and the third thumbnail according to the moving coordinates of the user's finger when the second designated event is ended. If the overlapped area is larger than a preset value, it is determined that the moving coordinates of the user's finger in the second designated event enter the range of the third thumbnail in the desktop management menu. According to the information of the second thumbnail and the information of the third thumbnail, the location of the second thumbnail in the desktop management menu is switched to that of the third thumbnail, and the location of the third thumbnail may be switched to that of the second thumbnail, or the third thumbnail and each of the following thumbnails are sequentially moved in the rearward direction.

It is noted that, for the adjustment of the screen sequence, in order to avoid the screen sequence being disordered, the object screen is considered to be confirmed by the user when the overlapped area between screens is larger than a certain proportion of the screen. Thus, in this embodiment, the overlapped area between the second thumbnail and the third thumbnail is calculated. If the overlapped area is larger than a preset value, it is determined that the moving coordinates of the user's finger in the drag event enter the range of the third thumbnail in the desktop management menu.

In this embodiment, when the location of the second thumbnail in the desktop management menu is switched to that of the third thumbnail, the third thumbnail may be processed in two manners, i.e., the location of the third thumbnail may be switched to that of the second thumbnail, or the third thumbnail and each of the following thumbnails are sequentially moved in the rearward direction. The specific selection for the process manner may be set by a technician at the development stage or by a terminal user according to his/her own usage preference.

Further, if the overlapped area is larger than or equal to a preset value, it is determined that the moving coordinates of the user's finger in the drag event have not entered the range of the third thumbnail in the desktop management menu. In this case, no process is made to the third thumbnail and the location of the second thumbnail in the desktop management menu is recovered.

Optionally, the apparatus may further comprise the following module.

A second mode switching module 70 is configured to switch the current screen to a drag and drop mode, when a second designated event is monitored, the operation object of the first designated event is the current screen, and the operation object of the second designated event is the second thumbnail in the desktop management menu.

Optionally, the first designated event is a slide event in which the user's finger slides upwardly by a distance longer than or equal to a designated event, and the second designated event is a long-press and drag event to the second thumbnail.

Optionally, the apparatus may further comprise the following module.

An updating module 80 is configured to update data in the desktop management database regarding the operation object of the first designated event and/or the screen corresponding to the target thumbnail of the second designated in the desktop management menu according to the process to the operation object of the first designated event and the screen corresponding to the target thumbnail of the second designated in the desktop management menu.

Optionally, the apparatus may further comprise the following module.

A desktop management menu processing module 90 is configured to contract the desktop management menu or configured to contract the desktop management menu when a third designated event is received, wherein the third designated event may be a slide event in which the user's finger slides downwardly by a distance longer than or equal to a designated distance or other instructions for contracting the desktop management menu.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient.

The apparatus for desktop management according to the embodiment as shown in FIG. 7 includes all the above-mentioned optional technical solutions in the description. However, in practice, all or some of the above-mentioned optional technical solutions may be combined in any way to form an optional technical solution of the disclosure, the detailed description of which is omitted here.

The apparatus for desktop management according to the embodiment implements the desktop management by using the above modules, belongs to the same implementing mechanism as the relevant method embodiments, and thus can refer to the description in the relevant method embodiments, the detailed description of which is thus omitted.

It is noted that the apparatus for desktop management provided in this embodiment is described according to division of each functional modules for the desktop management as an example. In practical applications, it is possible to assign the functions to different functional modules, i.e., to divide the internal structure of the apparatus into different functional modules to implement all or some of the functions. In addition, the apparatus for desktop management provided in this embodiment and the method for desktop management of the previously described embodiment belong to a same concept. The detailed implementing process may refer to the method for desktop management, the detailed description of which is thus omitted.

FIG. 8 is a schematic structural block view of a terminal to an embodiment of the disclosure. As shown in FIG. 8, the terminal comprises the following components.

The terminal 800 comprises a memory 801 and at least one processor 802.

The memory stores software programs and modules, such as the program instructions and modules corresponding to the terminal according to this embodiment, and data generated during the implementation of the terminal's desktop management according to this embodiment. The processor 802 implements various functional applications and data processing to implement the function of desktop management in this embodiment by executing the software programs and modules stored in the memory 801.

The processor 802 is configured to perform the following operations for the desktop management:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored.

In the embodiment, displaying a desktop management menu which comprises thumbnails of all screens of the desktop when a first designated event is monitored comprises:
when the first designated event is monitored, retrieving data of all screens of the desktop from a desktop management database, generating a thumbnail of each of the screens correspondingly according to the data of all screens of the desktop, and displaying the desktop management menu which comprises thumbnails of all screens of the desktop.

In the embodiment, processing an operation object of the first designated event and a screen corresponding to a target thumbnail of a second designated event in the desktop management menu according to the second designated event when the second designated event is monitored comprises:
recording icon information of at least one icon in the current screen when the second designated event is monitored and the operation object of the first designated event is the at least one icon;
rendering the at least one icon as a user's finger moves according to moving coordinates of the user's finger and the icon information of the at least one icon; and
adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

In the embodiment, the terminal is further configured to:
calculate remaining space of the screen corresponding to the first thumbnail when the moving coordinates of the user's finger enter the range of the first thumbnail while the at least one icon is rendered as the user's finger moves;
determine whether the screen corresponding to the first thumbnail has enough remaining space to accommodate the at least one icon according to the remaining space and a number of the at least one icon; and
display a first color in the range of the first thumbnail if it is the case, and displaying a second color in the range of the first thumbnail if it is not the case.

In the embodiment, the terminal is further configured to:
calculate remaining space of the screen corresponding to each thumbnail in the desktop management menu when the second designated event is monitored;
determine whether the screen corresponding to each thumbnail has enough remaining space to accommodate the at least one icon according to the remaining space of the each thumbnail and a number of the at least one icon;
display a first color in the range of thumbnails corresponding to the screens having enough remaining space to accommodate the at least one icon if it is the case; and
display a second color in the range of thumbnails corresponding to the screens having insufficient remaining space to accommodate the at least one icon if it is not the case.

In the embodiment, adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail comprises:
determining whether a first thumbnail, which is any one thumbnail in the desktop management menu, has enough remaining space to accommodate the at least one icon when it is monitored that the second designated event is ended and the moving coordinates of the user's finger in the second designated event enter the range of the first thumbnail, and adding the at least one icon into the screen corresponding to the first thumbnail according to the recorded icon information of the at least one icon if it is the case.

In the embodiment, the terminal is further configured to:
recover the at least one icon in an original screen of the at least one icon when the first thumbnail does not have enough remaining space to accommodate the at least one icon.

In the embodiment, the first designated event is a long-press event to the at least one icon, and the second designated event is a drag event to the at least one icon.

In the embodiment, displaying a desktop management menu which comprises thumbnails of all screens of the desktop when a first designated event is monitored comprises:
switching the current screen into a drag and drop mode when the first designated event is monitored.

In the embodiment, processing an operation object of the first designated event and a screen corresponding to a target thumbnail of a second designated event in the desktop management menu according to the second designated event when the second designated event is monitored comprises:
acquiring clicking coordinates of the user's finger in the second designated event when the second designated event is monitored and the operation object of the first designated event is the current screen;
the thumbnail in the desktop management menu in which the clicking coordinates are located being the target thumbnail of the second designated event; and
switching the current screen to the screen in the desktop management menu corresponding to the target thumbnail.

In the embodiment, switching the current screen to the screen in the desktop management menu corresponding to the target thumbnail comprises:
acquiring an index number of the screen corresponding to the target thumbnail; and
switching the current screen to the screen in the desktop management menu corresponding to the target thumbnail according to the index number of the screen corresponding to the target thumbnail.

In the embodiment, the first designated event is a slide event in which the user's finger slides upwardly by a distance long than or equal to a designated distance, and the second designated event is a clicking event.

In the embodiment, processing an operation object of the first designated event and a screen corresponding to a target thumbnail of a second designated event in the desktop management menu according to the second designated event when the second designated event is monitored comprises:
recording information of a second thumbnail in the desktop management menu when the second designated event is monitored, the operation object of the first designated event is the current screen, and the operation object of the second designated event is the second thumbnail;
rendering the second thumbnail as the user's finger moves according to the moving coordinates of the user's finger in the second designated event and the information of the second thumbnail; and
modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

In the embodiment, modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail comprises:
when it is monitored that the second designated event is ended, calculating an overlapped area between the second thumbnail and the third thumbnail according to the moving coordinates of the user's finger when the second designated event is ended, wherein, if the overlapped area is larger than a preset value, it is determined that the the moving coordinates of the user's finger in the second designated event enter the range of the third thumbnail;
switching the location of the second thumbnail to the location of the third thumbnail in the desktop management menu, and switching the location of the third thumbnail to the original location of the second thumbnail or moving the locations of the third thumbnail and thumbnails following the third thumbnail sequentially in the rearward direction according to the information of the second thumbnail and the information of the third thumbnail.

In the embodiment, the terminal is further configured to:
switch the desktop management menu into a drag and drop mode when the second designated event is monitored, the operation object of the first designated event is the current screen and the operation object of the second designated event is the second thumbnail in the desktop management menu.

In the embodiment, the first designated event is a slide event in which the user's finger slides upwardly by a distance longer than or equal to a designated distance, and the second designated event is a long-press and drag event to the second thumbnail.

In the embodiment, after processing an operation object of the first designated event and a screen corresponding to a target thumbnail of a second designated event in the desktop management menu according to the second designated event when the second designated event is monitored, the method further comprising:
updating data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

In the embodiment, after processing an operation object of the first designated event and a screen corresponding to a target thumbnail of a second designated event in the desktop management menu according to the second designated event when the second designated event is monitored, the method further comprising:
contracting the desktop management menu; or
contracting the desktop management menu when a third designated event is received.

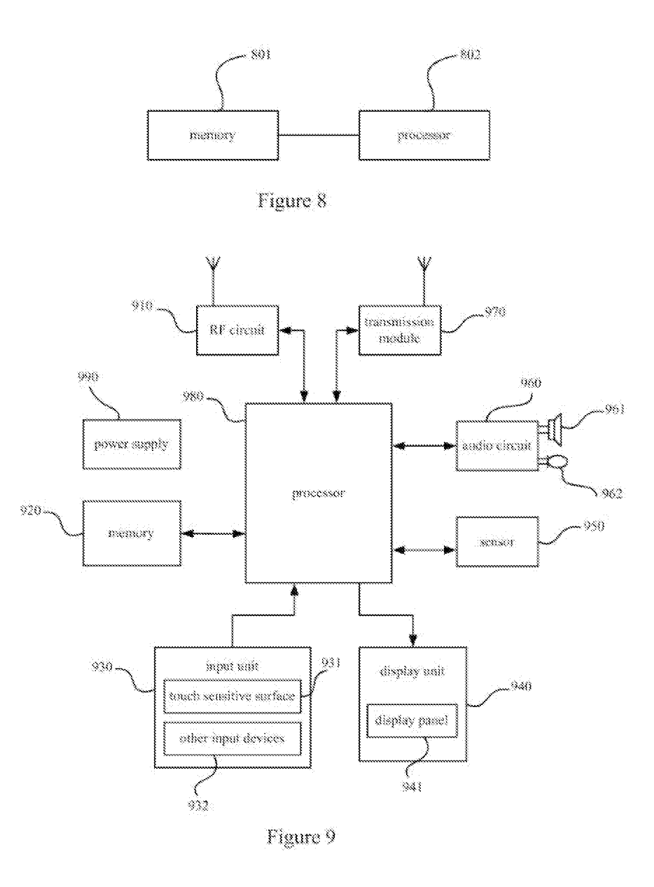

Preferably, as shown in FIG. 9, the terminal 800 is formed by the following units:
a Radio Frequency (RF) circuit 910, one or more memories 920 constituted by compute readable storing medium, an input unit 930, a display unit 940, a sensor 950, an audio circuit 960, a transmission module 970, a processor 980 with one or more processing cores, a power supply 990, and the like.

It is understood by the skilled in the art that the terminal structure as shown in FIG. 7 is not intended to limit the terminal, but can include more or less components, a combination of some components, or different arrangement of components.

The RF circuit 910 may be used for receiving and transmitting signals during transmitting/receiving or communicating process. In particular, upon receiving downlink information from a base station, the RF circuit 910 transmits the received information to one or more process 980 for processing. In addition, relevant uplink data is sent to the base station. Usually, the RF circuit 910 includes, but is not limited to, an antenna, at least one amplifier, a tuner, one or more resonators, a Subscriber Identity Module (SIM) card, a transceiver, a coupler, a Low Noise Amplifier (LNA), a duplexor, etc. In addition, the RF circuit 910 can be implemented by communication with a network and other devices by wireless communication. The wireless communication can use any communication standard or protocol, including but not limited in Global System of Mobile (GSM) communication, General Packet Radio Service (GPRS), Code Division Multiple Access (CDMA), Wideband Code Division Multiple Access (WCDMA), Long Term Evolution (LTE), email, Short Messaging Service (SMS), etc.

The memory 920 may be used for storing software programs and modules, such as the program instructions and modules corresponding to the terminal according to this embodiment, and data generated during the implementation of the terminal's desktop management according to this embodiment. The processor 980 implements various functional applications and data processing to implement the function of desktop management in this embodiment by executing the software programs and modules stored in the memory 820. The memory 920 can mainly include a program storing area and a data storing area. The program storing area may store an operating system and an application required for at least one function such as a sound play function and an image play function, etc. The data storing area may store data created according to the usage of the terminal 800 such as audio data and phone book, etc. In addition, the memory 920 may include a high-speed random access memory. The memory 920 may further include a non-volatile solid state memory such as at least one magnetic disk memory and a flash memory, or other volatile solid state memory. Correspondingly, the memory 920 may further include a storage controller to provide access of the processor 980 and the input unit 930 to the memory 920.

The input unit 930 may be used for receiving information regarding input numbers or characters to generate signal input of keyboard, mouse, operating bar, optical or track ball associated with customer setting and function control. Specifically, the input unit 930 may include a touch sensitive surface 931 and other input devices 932. The touch sensitive surface 931 is also referred as a touch display screen or a touch panel, which is able to capture touch operation by the user on or near the surface (for example, operation of an object or attachment such as user's finger or touch pen on or near the touch sensitive surface 931) and drive a corresponding coupled device according to preset program. Optionally, the touch sensitive surface 931 may include a touch sensor and a touch controller. The touch sensor may sense the orientation of the user's touch and sense the signal caused by the touch operation to send the signal to the touch controller. The touch controller receives touch information from the touch sensor and transforms the signal into touch coordinates for sending to the processor 980, and receives instructions from the processor 980 for execution. In addition, the touch sensitive surface 931 may be implemented as a resistive, capacitive, infrared touch sensitive surface 931 or a surface acoustic wave (SAW) touch sensitive surface 931. The input unit 930 may include other input devices 932 in addition to the touch sensitive surface 931. Specifically, the other input devices 932 may include but not limited to one or more of a physical keyboard, functional keys (such as a control key and a switch key), a track ball, a mouse, an operating bar, etc.

The display unit 940 may be used for displaying information input by the user, information provided to the user and various graphical user interfaces of the terminal 800. The graphical user interfaces may be formed by graphs, texts, icons, videos and any combination thereof. The display unit 940 may include a display panel 941. Optionally, the display panel 941 may be configured in the form of Liquid Crystal Display (LCD), Organic Light-Emitting Diode (OLED), etc. Further, the touch sensitive surface 931 may covers on the display panel 941. When the touch sensitive surface 931 senses a touch operation on or near the touch sensitive surface 931, the information is sent to the processor 980 for determining the type of the touch event. Then, the processor 980 provides corresponding visual output according to the type of the touch event. Although the touch sensitive surface 931 and the display panel 941 are provided as two individual components to implement the input and output functions as shown in FIG. 9, in some embodiments, the touch sensitive surface 931 and the display panel 941 may be integrated together to implement the input and output functions.

The terminal 800 may further comprise at least one sensor 950 such as an optical sensor, a sports sensor and other sensors. Specifically, the optical sensor may include an ambient light sensor and a proximity sensor, in which the ambient light sensor may adjust the lightness of display panel 941 according to the lightness or darkness of the ambient light, and the proximity sensor may close the display panel 941 or the backlight when the terminal 800 is moved to the proximity of the user's ear. As one kind of sports sensor, the gravitational acceleration sensor may detect the acceleration in individual direction (usually, in three axes) and the magnitude and direction of gravity when the terminal is static, which is useful for an application for identifying the posture of the terminal (such as the switch between horizontal screen and vertical screen, relevant games, posture calibration of a magnetometer), vibration identification related functions (such as a passometer and a hitting), etc. The terminal 800 may further be provided with sensors such as a gyroscope, a barometer, a hygrometer, a thermometer and an infrared sensor, the description of which is omitted here.

The audio circuit 960, a speaker 961 and a microphone 962 may provide audio interface between the user and the terminal 800. The audio circuit 960 may send an electrical signal transformed from the received audio data to the speaker 961 for output as a sound signal. In another aspect, the microphone 962 transforms the collected sound signal into an electrical signal, which is transformed into audio data after being received by the audio circuit 960. The audio data is output to the processor 980 for processing, and then send by the RF circuit 910 for example to another terminal or output to the memory 920 for further processing. The audio circuit 960 may further comprise a socket for an earphone so as to provide a communication between an external earphone and the terminal.

WiFi is to a short-distance wireless transmission technology. The terminal 800 may transmit/receive emails, browse webpages and access stream medium through a WiFi module 970, which provides the user with a wireless broadband Internet access. Although a WiFi module 970 is shown in FIG. 9, it is understood that this module is not necessary to be contained in the terminal 800 and can be omitted as required within the scope of this invention.

The processor 980 is the control center of the terminal 800, which connects individual parts of the cell phone by various interface and lines. The processor 980 performs various functions of the terminal and processes data by running or executing software programs and/or modules of the terminal 800 and invoking data stored in the memory 920 so as to monitor the cell phone on the whole. Optionally, the processor 980 may include one or more processing cores. Preferably, the processor 980 may integrate an application processor and a moddemod processor, wherein the application processor mainly processes the operation system, the user interface and the application pragrams, and the moddemod processor mainly processes wireless communication. It is understood that the moddemod processor may not be integrated in the processor 980.

The terminal 800 may further comprise a power supply 990 (such as a battery) for supplying power to individual components. Preferably, the power supply may be logically connected with the processor 980 via a power supply management system so that functions such as charging, discharging and power consumption are managed by the power supply management system. The power supply 990 may further comprise one or more DC or AC power supplies, rechargeable systems, power supply error detecting circuits, power supply transformers or inverters, power supply state indicators, etc.

The terminal may further comprise a camera, a bluetooth module, etc. (not shown), the description of which is omitted here.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient.

An embodiment further provides a computer readable medium. The computer readable medium may be a computer readable medium contained in a memory in the above-described embodiment or a separate computer readable medium uninstalled into the terminal. The computer readable medium may stores one or more programs to be executed by one or more processors for performing a desktop management method comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored.

In the embodiment, displaying a desktop management menu which comprises thumbnails of all screens of the desktop when a first designated event is monitored comprises:
when the first designated event is monitored, retrieving data of all screens of the desktop from a desktop management database, generating a thumbnail of each of the screens correspondingly according to the data of all screens of the desktop, and displaying the desktop management menu which comprises thumbnails of all screens of the desktop.

In the embodiment, processing an operation object of the first designated event and a screen corresponding to a target thumbnail of a second designated event in the desktop management menu according to the second designated event when the second designated event is monitored comprises:
recording icon information of at least one icon in the current screen when the second designated event is monitored and the operation object of the first designated event is the at least one icon;
rendering the at least one icon as a user's finger moves according to moving coordinates of the user's finger and the icon information of the at least one icon; and
adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

In the embodiment, the method further comprises:
calculating remaining space of the screen corresponding to the first thumbnail when the moving coordinates of the user's finger enter the range of the first thumbnail while the at least one icon is rendered as the user's finger moves;
determining whether the screen corresponding to the first thumbnail has enough remaining space to accommodate the at least one icon according to the remaining space and a number of the at least one icon; and
displaying a first color in the range of the first thumbnail if it is the case, and displaying a second color in the range of the first thumbnail if it is not the case.

In the embodiment, the method further comprises:
calculating remaining space of the screen corresponding to each thumbnail in the desktop management menu when the second designated event is monitored;
determining whether the screen corresponding to each thumbnail has enough remaining space to accommodate the at least one icon according to the remaining space of the each thumbnail and a number of the at least one icon;
displaying a first color in the range of thumbnails corresponding to the screens having enough remaining space to accommodate the at least one icon if it is the case; and
displaying a second color in the range of thumbnails corresponding to the screens having insufficient remaining space to accommodate the at least one icon if it is not the case.

In the embodiment, adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail comprises:
determining whether a first thumbnail, which is any one thumbnail in the desktop management menu, has enough remaining space to accommodate the at least one icon when it is monitored that the second designated event is ended and the moving coordinates of the user's finger in the second designated event enter the range of the first thumbnail, and adding the at least one icon into the screen corresponding to the first thumbnail according to the recorded icon information of the at least one icon if it is the case.

In the embodiment, the method further comprises:
recovering the at least one icon in an original screen of the at least one icon when the first thumbnail does not have enough remaining space to accommodate the at least one icon.

In the embodiment, the first designated event is a long-press event to the at least one icon, and the second designated event is a drag event to the at least one icon.

In the embodiment, displaying a desktop management menu which comprises thumbnails of all screens of the desktop when a first designated event is monitored comprises:
switching the current screen into a drag and drop mode when the first designated event is monitored.

In the embodiment, processing an operation object of the first designated event and a screen corresponding to a target thumbnail of a second designated event in the desktop management menu according to the second designated event when the second designated event is monitored comprises:
acquiring clicking coordinates of the user's finger in the second designated event when the second designated event is monitored and the operation object of the first designated event is the current screen;
the thumbnail in the desktop management menu in which the clicking coordinates are located being the target thumbnail of the second designated event; and
switching the current screen to the screen in the desktop management menu corresponding to the target thumbnail.

In the embodiment, switching the current screen to the screen in the desktop management menu corresponding to the target thumbnail comprises:
acquiring an index number of the screen corresponding to the target thumbnail; and
switching the current screen to the screen in the desktop management menu corresponding to the target thumbnail according to the index number of the screen corresponding to the target thumbnail.

In the embodiment, the first designated event is a slide event in which the user's finger slides upwardly by a distance long than or equal to a designated distance, and the second designated event is a clicking event.

In the embodiment, processing an operation object of the first designated event and a screen corresponding to a target thumbnail of a second designated event in the desktop management menu according to the second designated event when the second designated event is monitored comprises:
recording information of a second thumbnail in the desktop management menu when the second designated event is monitored, the operation object of the first designated event is the current screen, and the operation object of the second designated event is the second thumbnail;
rendering the second thumbnail as the user's finger moves according to the moving coordinates of the user's finger in the second designated event and the information of the second thumbnail; and
modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

In the embodiment, modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail comprises:
when it is monitored that the second designated event is ended, calculating an overlapped area between the second thumbnail and the third thumbnail according to the moving coordinates of the user's finger when the second designated event is ended, wherein, if the overlapped area is larger than a preset value, it is determined that the the moving coordinates of the user's finger in the second designated event enter the range of the third thumbnail;
switching the location of the second thumbnail to the location of the third thumbnail in the desktop management menu, and switching the location of the third thumbnail to the original location of the second thumbnail or moving the locations of the third thumbnail and thumbnails following the third thumbnail sequentially in the rearward direction according to the information of the second thumbnail and the information of the third thumbnail.

In the embodiment, the method further comprises:
switching the desktop management menu into a drag and drop mode when the second designated event is monitored, the operation object of the first designated event is the current screen and the operation object of the second designated event is the second thumbnail in the desktop management menu.

In the embodiment, the first designated event is a slide event in which the user's finger slides upwardly by a distance longer than or equal to a designated distance, and the second designated event is a long-press and drag event to the second thumbnail.

In the embodiment, after processing an operation object of the first designated event and a screen corresponding to a target thumbnail of a second designated event in the desktop management menu according to the second designated event when the second designated event is monitored, the method further comprising:
updating data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

In the embodiment, after processing an operation object of the first designated event and a screen corresponding to a target thumbnail of a second designated event in the desktop management menu according to the second designated event when the second designated event is monitored, the method further comprising:
contracting the desktop management menu; or
contracting the desktop management menu when a third designated event is received.

According to the method for desktop management provided in this embodiment, the gesture operation event to the current screen is monitored. When the first designated event is monitored, the desktop management menu is displayed. The desktop management menu comprises thumbnail of all screens in the desktop. When the second designated event is monitored, the operation object of the first designated event and the screen corresponding to the target thumbnail of the second designated event in the desktop management menu are processed according to the second designated event. Using the technical solution provided in this disclosure, during the desktop management process, the desktop management menu including thumbnails of all screens of the desktop is used as a locating target and considered as an agency of an actual locating target so that the locating operation is performed in a corresponding screen and a rapid location to the screen is achieved. According to such solution, the desktop operation is simple, rapid, and highly efficient.

It is understood by an ordinary person in the art that all or part of the technical solutions disclosed above may be implemented by hardware or program instructions for instructing hardware. The program may be stored in a computer-readable storing medium such as a hard disk, a read-only memory (ROM), a floppy disk, an optical disk or the like.

The above described embodiments are merely illustrative instead of limiting. Any modifications, equivalent alternations and improvements that are made within the spirit and scope of the appended claims should be included in the scope of the invention.

1. (canceled)

2. (canceled)

3. A method for managing a desktop, comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored,
wherein processing an operation object of the first designated event and a screen corresponding to a target thumbnail of a second designated event in the desktop management menu according to the second designated event when the second designated event is monitored comprises:
recording icon information of at least one icon in the current screen when the second designated event is monitored and the operation object of the first designated event is the at least one icon;
rendering the at least one icon as a user's finger moves according to moving coordinates of the user's finger and the icon information of the at least one icon; and
adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

4. The method according to claim 3, further comprising:
calculating remaining space of the screen corresponding to the first thumbnail when the moving coordinates of the user's finger enter the range of the first thumbnail while the at least one icon is rendered as the user's finger moves;
determining whether the screen corresponding to the first thumbnail has enough remaining space to accommodate the at least one icon according to the remaining space and a number of the at least one icon; and
displaying a first color in the range of the first thumbnail if it is the case, and displaying a second color in the range of the first thumbnail if it is not the case.

5. The method according to claim 3, further comprising:
calculating remaining space of the screen corresponding to each thumbnail in the desktop management menu when the second designated event is monitored;
determining whether the screen corresponding to each thumbnail has enough remaining space to accommodate the at least one icon according to the remaining space of the each thumbnail and a number of the at least one icon;
displaying a first color in the range of thumbnails corresponding to the screens having enough remaining space to accommodate the at least one icon if it is the case; and
displaying a second color in the range of thumbnails corresponding to the screens having insufficient remaining space to accommodate the at least one icon if it is not the case.

6. The method according to claim 3, wherein adding the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail comprises:
determining whether a first thumbnail, which is any one thumbnail in the desktop management menu, has enough remaining space to accommodate the at least one icon when it is monitored that the second designated event is ended and the moving coordinates of the user's finger in the second designated event enter the range of the first thumbnail, and adding the at least one icon into the screen corresponding to the first thumbnail according to the recorded icon information of the at least one icon if it is the case.

7. The method according to claim 3, further comprising:
recovering the at least one icon in an original screen of the at least one icon when the first thumbnail does not have enough remaining space to accommodate the at least one icon.

8. (canceled)

9. The method according to claim 3, wherein displaying a desktop management menu which comprises thumbnails of all screens of the desktop when a first designated event is monitored comprises:
switching the current screen into a drag and drop mode when the first designated event is monitored.

10. A method for managing a desktop, comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored,
wherein processing an operation object of the first designated event and a screen corresponding to a target thumbnail of a second designated event in the desktop management menu according to the second designated event when the second designated event is monitored comprises:
acquiring clicking coordinates of the user's finger in the second designated event when the second designated event is monitored and the operation object of the first designated event is the current screen;
the thumbnail in the desktop management menu in which the clicking coordinates are located being the target thumbnail of the second designated event; and
switching the current screen to the screen in the desktop management menu corresponding to the target thumbnail.

11. The method according to claim 10, wherein switching the current screen to the screen in the desktop management menu corresponding to the target thumbnail comprises:
acquiring an index number of the screen corresponding to the target thumbnail; and
switching the current screen to the screen in the desktop management menu corresponding to the target thumbnail according to the index number of the screen corresponding to the target thumbnail.

12. The method according to claim 10, wherein the first designated event is a slide event in which the user's finger slides upwardly by a distance long than or equal to a designated distance, and the second designated event is a clicking event.

13. A method for managing a desktop, comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored,
wherein processing an operation object of the first designated event and a screen corresponding to a target thumbnail of a second designated event in the desktop management menu according to the second designated event when the second designated event is monitored comprises:
recording information of a second thumbnail in the desktop management menu when the second designated event is monitored, the operation object of the first designated event is the current screen, and the operation object of the second designated event is the second thumbnail; rendering the second thumbnail as the user's finger moves according to the moving coordinates of the user's finger in the second designated event and the information of the second thumbnail; and
modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

14. The method according to claim 13, wherein modifying a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail comprises:
when it is monitored that the second designated event is ended, calculating an overlapped area between the second thumbnail and the third thumbnail according to the moving coordinates of the user's finger when the second designated event is ended, wherein, if the overlapped area is larger than a preset value, it is determined that the moving coordinates of the user's finger in the second designated event enter the range of the third thumbnail;
switching the location of the second thumbnail to the location of the third thumbnail in the desktop management menu, and switching the location of the third thumbnail to the original location of the second thumbnail or moving the locations of the third thumbnail and thumbnails following the third thumbnail sequentially in the rearward direction according to the information of the second thumbnail and the information of the third thumbnail.

15. The method according to claim 13, further comprising:
switching the desktop management menu into a drag and drop mode when the second designated event is monitored, the operation object of the first designated event is the current screen and the operation object of the second designated event is the second thumbnail in the desktop management menu.

16. The method according to claim 13, wherein the first designated event is a slide event in which the user's finger slides upwardly by a distance longer than or equal to a designated distance, and the second designated event is a long-press and drag event to the second thumbnail.

17. A method for managing a desktop, comprising:
monitoring a gesture operation event to a current screen;
displaying a desktop management menu which comprises thumbnails of all screens of the desktop when a first designated event is monitored;
processing an operation object of the first designated event and a screen corresponding to a target thumbnail of a second designated event in the desktop management menu according to the second designated event when the second designated event is monitored; and
updating data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

18. A method for managing a desktop, comprising:
monitoring a gesture operation event to a current screen;
displaying a desktop management menu which comprises thumbnails of all screens of the desktop when a first designated event is monitored; and
processing an operation object of the first designated event and a screen corresponding to a target thumbnail of a second designated event in the desktop management menu according to the second designated event when the second designated event is monitored; and contracting the desktop management menu; or
contracting the desktop management menu when a third designated event is received.

19. (canceled)

20. (canceled)

21. An apparatus for managing a desktop, comprising:
a monitoring module, configured to monitor a gesture operation event to a current screen;
a displaying module, configured to display a desktop management menu which comprises thumbnails of all screens of the desktop when a first designated event is monitored; and
a processing module, configured to process an operation object of the first designated event and a screen corresponding to a target thumbnail of a second designated event in the desktop management menu according to the second designated event when the second designated event is monitored, wherein the processing module comprises:
a recording unit, configured to record icon information of at least one icon in the current screen when the second designated event is monitored and the operation object of the first designated event is the at least one icon;
a rendering unit, configured to render the at least one icon as a user's finger moves according to moving coordinates of the user's finger and the icon information of the at least one icon; and
a processing unit, configured to add the at least one icon into the screen corresponding to a first thumbnail in the desktop management menu, which is any one thumbnail in the desktop management menu, according to the recorded icon information of the at least one icon when it is monitored that the second designated event is ended and the moving coordinates of the user's finger in the second designated event enter a range of the first thumbnail.

22. The apparatus according to claim 21, further comprising:
a first calculating unit, configured to calculate remaining space of the screen corresponding to the first thumbnail when the moving coordinates of the user's finger enter the range of the first thumbnail while the at least one icon is rendered as the user's finger moves;
a first determining module, configured to determine whether the screen corresponding to the first thumbnail has enough remaining space to accommodate the at least one icon according to the remaining space and a number of the at least one icon, wherein the displaying module is triggered to display a first color in the range of the first thumbnail if the first determining module determines that the screen corresponding to the first thumbnail has enough remaining space to accommodate the at least one icon, and the displaying module is triggered to display a second color in the range of the first thumbnail if the first determining module determines that the screen corresponding to the first thumbnail does not have enough remaining space to accommodate the at least one icon.

23. The apparatus according to claim 21, further comprising:
a second calculating module, configured to calculate remaining space of the screen corresponding to each thumbnail in the desktop management menu when the second designated event is monitored;
a second determining module, configured to determine whether the screen corresponding to each thumbnail has enough remaining space to accommodate the at least one icon according to the remaining space of the each thumbnail and a number of the at least one icon, wherein the displaying module is triggered to display a first color in the range of thumbnails corresponding to the screens having enough remaining space to accommodate the at least one icon if it is the case; and the displaying module is triggered to display a second color in the range of thumbnails corresponding to the screens having insufficient remaining space to accommodate the at least one icon if it is not the case.

24. The apparatus according to claim 21, wherein the processing unit is configured to determine, when it is monitored that the second designated event is ended and the moving coordinates of the user's finger in the second designated event enter a range of the first thumbnail, whether a first thumbnail, which is any one thumbnail in the desktop management menu, has enough remaining space to accommodate the at least one icon, and add the at least one icon into the screen corresponding to the first thumbnail according to the recorded icon information of the at least one icon if it is the case.

25. The apparatus according to claim 21, further comprising:
a recovering module, configured to recover the at least one icon in an original screen of the at least one icon when the first thumbnail does not have enough remaining space to accommodate the at least one icon.

26. (canceled)

27. The apparatus according to claim 21, further comprising:
a first mode switching module, configured to switch the current screen into a drag and drop mode when the first designated event is monitored.

28. An apparatus for managing a desktop, comprising:
a monitoring module, configured to monitor a gesture operation event to a current screen;
a displaying module, configured to display a desktop management menu which comprises thumbnails of all screens of the desktop when a first designated event is monitored; and
a processing module, configured to process an operation object of the first designated event and a screen corresponding to a target thumbnail of a second designated event in the desktop management menu according to the second designated event when the second designated event is monitored,
wherein the processing module comprises:
an acquiring unit, configured to acquire clicking coordinates of the user's finger in the second designated event when the second designated event is monitored and the operation object of the first designated event is the current screen, wherein the thumbnail in the desktop management menu in which the clicking coordinates are located is the target thumbnail of the second designated event; and
a switching unit, configured to switch the current screen to the screen in the desktop management menu corresponding to the target thumbnail.

29. The apparatus according to claim 28, wherein the switching unit is configured to acquire an index number of the screen corresponding to the target thumbnail, and switch the current screen to the screen in the desktop management menu corresponding to the target thumbnail according to the index number of the screen corresponding to the target thumbnail.

30. The apparatus according to claim 28, wherein the first designated event is a slide event in which the user's finger slides upwardly by a distance long than or equal to a designated distance, and the second designated event is a clicking event.

31. An apparatus for managing a desktop, comprising:
a monitoring module, configured to monitor a gesture operation event to a current screen;
a displaying module, configured to display a desktop management menu which comprises thumbnails of all screens of the desktop when a first designated event is monitored; and
a processing module, configured to process an operation object of the first designated event and a screen corresponding to a target thumbnail of a second designated event in the desktop management menu according to the second designated event when the second designated event is monitored,
wherein the processing module comprises:
a thumbnail information recording unit, configured to record information of a second thumbnail in the desktop management menu when the second designated event is monitored, the operation object of the first designated event is the current screen, and the operation object of the second designated event is the second thumbnail;
a thumbnail rendering unit, configured to render the second thumbnail as the user's finger moves according to the moving coordinates of the user's finger in the second designated event and the information of the second thumbnail; and
a modifying unit, configured to modify a location sequence of the screen corresponding to the second thumbnail according to the information of the second thumbnail and the information of a third thumbnail in the desktop management menu when it is monitored that the second designated is ended and the moving coordinates of the user's finger in the second designated event enter the range of the third thumbnail.

32. The apparatus according to claim 31, wherein the modifying unit is configured to calculate, when it is monitored that the second designated event is ended, an overlapped area between the second thumbnail and the third thumbnail according to the moving coordinates of the user's finger when the second designated event is ended, wherein, if the overlapped area is larger than a preset value, it is determined that the moving coordinates of the user's finger in the second designated event enter the range of the third thumbnail; and is configured to switch the location of the second thumbnail to the location of the third thumbnail in the desktop management menu, and switch the location of the third thumbnail to the original location of the second thumbnail or move the locations of the third thumbnail and thumbnails following the third thumbnail sequentially in the rearward direction according to the information of the second thumbnail and the information of the third thumbnail.

33. The apparatus according to claim 31, further comprising:
a second mode switching module, configured to switch the desktop management menu into a drag and drop mode when the second designated event is monitored, the operation object of the first designated event is the current screen and the operation object of the second designated event is the second thumbnail in the desktop management menu.

34. The apparatus according to claim 31, the first designated event is a slide event in which the user's finger slides upwardly by a distance longer than or equal to a designated distance, and the second designated event is a long-press and drag event to the second thumbnail.

35. An apparatus for managing a desktop, comprising:
a monitoring module, configured to monitor a gesture operation event to a current screen;
a displaying module, configured to display a desktop management menu which comprises thumbnails of all screens of the desktop when a first designated event is monitored;
a processing module, configured to process an operation object of the first designated event and a screen corresponding to a target thumbnail of a second designated event in the desktop management menu according to the second designated event when the second designated event is monitored; and
an updating module, configured to update data in the desktop management database regarding the operation object of the first designated event and/or the screen corresponding to the target thumbnail of the second designated event in the desktop management menu according to the process to the operation object of the first designated event and the screen corresponding to the target thumbnail of the second designated event in the desktop management menu.

36. An apparatus for managing a desktop, comprising:
a monitoring module, configured to monitor a gesture operation event to a current screen;
a displaying module, configured to display a desktop management menu which comprises thumbnails of all screens of the desktop when a first designated event is monitored;
a processing module, configured to process an operation object of the first designated event and a screen corresponding to a target thumbnail of a second designated event in the desktop management menu according to the second designated event when the second designated event is monitored; and
a desktop management menu processing module, configured to contract the desktop management menu; or contract the desktop management menu when a third designated event is received.
